(19) United States
(12) Patent Application Publication
(10) Pub. No.: US 2013/0235910 A1
(43) Pub. Date: Sep. 12, 2013

(54) COMMUNICATION APPARATUS, ELECTRONIC APPARATUS, RELAY NODE, COMMUNICATION METHOD, AND COMMUNICATION SYSTEM

(71) Applicant: SONY CORPORATION, Tokyo (JP)

(72) Inventor: Takanori Washiro, Kanagawa (JP)

(73) Assignee: Sony Corporation, Tokyo (JP)

(21) Appl. No.: 13/769,851

(22) Filed: Feb. 19, 2013

(30) Foreign Application Priority Data
Mar. 7, 2012 (JP) 2012-050434

(51) Int. Cl. H04B 3/54

(52) U.S. Cl. CPC H04B 3/542
USPC 375/211; 375/295; 375/350; 375/257

(57) ABSTRACT

Provided is a communication apparatus including a port that connects a power line, along which power is transmitted at a given frequency, to an external apparatus, a transmitter that transmits, via the power line, a carrier signal obtained by modulating a transmit signal that has been obtained by encoding a processing command for executing a given process, at a carrier frequency higher than the frequency of the power, and a communication filter, connected between the power line and the transmitter, that at least blocks signals at the frequency of the power, while not blocking signals at the carrier frequency.

### BACKGROUND

The present disclosure relates to a communication apparatus, an electronic apparatus, a relay node, a communication method, and a communication system.

There have been proposed systems which utilize a technology called power line communication (PLC) which uses a power line as a communication line. For example, such a system may utilize PLC to control devices connected to the power line by having a server transmit signals related to operating the device via the power line. The technology described in Japanese Unexamined Patent Application Publication No. 2003-110471 may be cited as an example of technology related to a power line signal transceiving system that communicates via a power line using PLC.

### SUMMARY

In the case of conducting wired communication through a power line by using existing PLC technology such as the technology described in Japanese Unexamined Patent Application Publication No. 2003-110471, for example, the apparatus that communicates is usually provided with a communication device called a PLC modem having comparatively large-scale circuitry, for example. For this reason, conducting wired communication using existing PLC carries the risk of increases in the cost of the apparatus that communicates, and in addition, the risk that restrictions may be imposed on the size of the apparatus that communicates.

According to an embodiment of the present disclosure, there is proposed a new and improved communication apparatus, relay node, communication method, and communication system able to cause an electronic apparatus to conduct a process based on processing commands transmitted via a power line. In addition, according to an embodiment of the present disclosure, there is proposed a new and improved electronic apparatus able to conduct a process based on processing commands transmitted via a power line.

According to an embodiment of the present disclosure, there is provided a communication apparatus including a port that connects a power line, along which power is transmitted at a given frequency, to an external apparatus, a transmitter that transmits, via the power line, a carrier signal obtained by modulating a transmit signal that has been obtained by encoding a processing command for executing a given process, at a carrier frequency higher than the frequency of the power, and a communication filter, connected between the power line and the transmitter, that at least blocks signals at the frequency of the power, while not blocking signals at the carrier frequency.

Further, according to an embodiment of the present disclosure, there is provided an electronic apparatus including a receiver that receives, via a power line along which power is transmitted, a carrier signal obtained by modulating a transmit signal that has been obtained by encoding a processing command for executing a given process, at a carrier frequency higher than the frequency of the power, a communication filter, connected between the power line and the receiver, that at least blocks signals at the frequency of the power, while not blocking signals at the carrier frequency, and a processor that conducts a process indicated by the processing commands corresponding to the received carrier signal.

Further, according to an embodiment of the present disclosure, there is provided a relay node including a receiver that receives, via a power line along which power is transmitted, a carrier signal obtained by modulating a transmit signal that has been obtained by encoding a processing command for executing a given process, at a carrier frequency higher than the frequency of the power, a communication filter, connected between the power line and the receiver, that at least blocks signals at the frequency of the power, while not blocking signals at the carrier frequency, and a transmitter that transmits the transmit signal corresponding to the received carrier signal to an external apparatus.

Further, according to an embodiment of the present disclosure, there is provided a communication method including generating a transmit signal obtained by encoding a processing command for executing a given process, and transmitting, via a power line, a carrier signal obtained by modulating the transmit signal at a carrier frequency higher than the frequency of the power.

Further, according to an embodiment of the present disclosure, there is provided a communication system including a communication apparatus, and a control apparatus that communicates with the communication apparatus and transmits a transmit request to the communication apparatus. The communication apparatus includes a port that connects a power line, along which power is transmitted at a given frequency, to an external apparatus, a transmitter that transmits, via the power line and on the basis of the transmit request, a carrier signal obtained by modulating a transmit signal that has been obtained by encoding a processing command for executing a given process, at a carrier frequency higher than the frequency of the power, and a communication filter, connected between the power line and the transmitter, that at least blocks signals at the frequency of the power, while not blocking signals at the carrier frequency.

According to an embodiment of the present disclosure, it is possible to cause an electronic apparatus to conduct a process based on processing commands transmitted via a power line. Also, according to an embodiment of the present disclosure, it is possible to conduct a process based on processing commands transmitted via a power line.

### BRIEF DESCRIPTION OF THE DRAWINGS

FIG. 1 illustrates an example of a signal generated and transmitted by a process in accordance with a communication method for a communication apparatus according to the embodiments;

FIG. 2 illustrates the significance of conducting double modulation when a communication apparatus according to the embodiments generates a transmit signal;

FIG. 3 is a flowchart illustrating an example of a process in accordance with a communication method for a communication apparatus according to the embodiments;

FIG. 4 is a flowchart illustrating another example of a process in accordance with a communication method for a communication apparatus according to the embodiments;

FIG. 5 illustrates exemplary configurations of a communication apparatus according to the first embodiment and an electronic apparatus according to the first embodiment;

FIG. 6 illustrates exemplary configurations of a transmitter, a first filter, and a second filter provided in a communication apparatus according to the first embodiment;

FIG. 7 illustrates exemplary configurations of a first filter, a receiver, and a second filter provided in an electronic apparatus according to the first embodiment;

FIG. 8 illustrates another exemplary configuration of a receiver provided in an electronic apparatus according to the first embodiment;

FIG. 9 illustrates an exemplary configuration of a communication apparatus according to the second embodiment and an electronic apparatus according to the second embodiment;

FIG. 10 illustrates an exemplary configuration of a power line communication unit provided in a communication apparatus according to the second embodiment;

FIG. 11 illustrates another example of a power line communication unit provided in a communication apparatus according to the second embodiment;

FIG. 12 illustrates an exemplary configuration of a power line communication unit provided in an electronic apparatus according to the second embodiment;

FIG. 13 illustrates another exemplary configuration of a power line communication unit provided in an electronic apparatus according to the second embodiment; and

FIG. 14 illustrates an exemplary configuration of a relay node according to the embodiments.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description hereinafter will proceed in the following order.

1. Communication method according to the embodiments

2. Communication apparatus and electronic apparatus according to the embodiments

3. Relay node according to the embodiments

### (Communication Method According to the Embodiments)

Before describing the configuration of a communication apparatus, an electronic apparatus, and a relay node according to the embodiments, a communication method according to the embodiments will be described first.

By conducting wired communication using existing PLC, it is possible to transmit and receive processing commands for executing a given process between apparatus connected via a power line, for example.

However, as discussed earlier, conducting wired communication using existing PLC carries the risk of increases in the cost of the apparatus that communicates, and in addition, the risk that restrictions may be imposed on the size of the apparatus that communicates. In practice, the embedding of PLC-related communication devices (such as PLC modems) into market-oriented products, for example, is not progressing.

[1] Process in Accordance with Communication Method for Communication Apparatus According to the Embodiments

Thus, a communication apparatus according to the embodiments impresses processing commands for executing a given process onto a power line according to a method that differs from existing PLC.

More specifically, a communication apparatus according to the embodiments generates a transmit signal in which processing commands are encoded (a signal generating process). A communication apparatus according to the embodiments then transmits, via a power line, a carrier signal modulated by the generated transmit signal at a carrier frequency that is higher than the power frequency (such as 50 Hz or 60 Hz) (a transmitting process).

Potential carrier signals according to the embodiments may include signals at the frequencies used for radio-frequency identification (RFID) or signals at the frequencies used for contactless communication in accordance with near field communication (NFC) technology, for example. However, the frequency of the carrier signal according to the embodiments (carrier frequency) is not limited to the above. For example, various frequencies such as 130 kHz to 135 kHz, 13.56 MHz, 56 MHz, 433 MHz, 954.2 MHz, 954.8 MHz, 2441.75 MHz, and 2448.875 MHz may be cited as examples of frequencies for a high-frequency signal.

In addition, a transmit signal according to the embodiments may be, for example, a signal obtained by encoding processing commands in binary and amplitude-modulating the encoded signal onto a carrier at a frequency lower than the carrier frequency.

### (1) Signal Generating Process

A communication apparatus according to the embodiments generates a transmit signal in which processing commands are encoded.

Herein, processing commands according to the embodiments may include, for example, processing commands indicated by processing command data received by an external apparatus, and processing commands indicated by processing command data acquired by a communication apparatus according to the embodiments on the basis of a determination result for a preset condition.

In the case where the processing commands according to the embodiments are processing commands indicated by processing command data received from an external apparatus, a communication apparatus according to the embodiments may generate a transmit signal on the basis of the received processing command data, for example. In other words, in the case where the processing commands according to the embodiments are processing commands indicated by processing command data received from an external apparatus, the processing commands included in the carrier signal transmitted by a communication apparatus according to the embodiments are equivalent to retransmissions that relay the processing commands indicated by the received processing command data.

Meanwhile, in the case where the processing commands according to the embodiments are processing commands indicated by processing command data acquired by a communication apparatus according to the embodiments, a communication apparatus according to the embodiments may, for example, retrieve processing command data containing the processing commands to transmit from a recording medium such as a storage unit (discussed later) provided in the communication apparatus according to the embodiments, and generate a transmit signal on the basis of the retrieved processing command data. Note that a communication apparatus according to the embodiments may also communicate with an external apparatus such as a server and generate a transmit signal on the basis of processing command data acquired from that external apparatus, for example. Additionally, it is also possible for a communication apparatus according to the embodiments to generate a transmit signal on the basis of a received transmit request that requests the transmission of processing commands in the case of receiving such a transmit request transmitted from an external apparatus such as a remote control or server.

However, the method of acquiring processing command data in a communication apparatus according to the embodiments is not limited to the above. For example, the following methods (a) to (c) may be cited as potential methods of acquiring processing command data in a communication apparatus according to the embodiments:

(a) a communication apparatus according to the embodiments downloads processing command data from a database on a network, on the basis of a device name for an electronic apparatus input by a user;

(b) a communication apparatus according to the embodiments acquires a device name for an electronic apparatus or other such data (an example of identification information to be later discussed) from an electronic apparatus connected to a power line by power line communication in accordance with the embodiments later discussed, and downloads processing command data corresponding to the electronic apparatus from a database on a network; and

(c) a communication apparatus according to the embodiments learns by recording commands input by a user to a recording medium such as a storage unit (discussed later), and assigning processes to commands stored in the recording medium (commonly referred to as a learning remote).

Herein, the following may be cited as potential preset conditions according to the embodiments and processing commands based on determination results for those conditions:

processing commands for taking the temperature, humidity, or illumination level to be a preset temperature, humidity, or illumination level when the current value for the temperature, humidity, or illumination level satisfies a preset threshold condition (exemplary condition);

processing commands for reducing power consumption according to a power-saving request when receiving such a power-saving request sent from a power company or other entity (exemplary condition); and

processing commands for executing one or multiple predefined processes when a trigger condition is satisfied on the basis of a program that defines a trigger condition and one or multiple processes for when that trigger condition is satisfied (exemplary condition).

More specifically, a communication apparatus according to the embodiments may encode processing commands in binary by subjecting the processing commands to pulse position modulation (PPM), for example (this corresponds to single modulation). In addition, a communication apparatus according to the embodiments may subject the binary-coded signal (single-modulated signal) to amplitude-shift keying (ASK) modulation at a frequency that is lower than the carrier frequency, such as 38 kHz to 40 kHz (this corresponds to double modulation).

By generating a transmit signal in the form of a single-modulated and double-modulated signal as above, for example, a communication apparatus according to the embodiments is able to generate a transmit signal according to the embodiments in the form of a signal that has been modulated similarly to a signal generated during infrared communication, for example. Since apparatus with infrared communication functions are widely prevalent, modules that generate signals in accordance with infrared communication are cheaper than PLC-based communication devices, with smaller-scale circuitry than PLC-based communication devices. Thus, as a result of a communication apparatus according to the embodiments generating a transmit signal according to the embodiments in the form of a signal that has been modulated similarly to a signal generated during infrared communication, it is possible to reduce the costs related to realizing a communication method according to the embodiments more than in the case of using PLC.

Note that a transmit signal generated by a communication apparatus according to the embodiments is not limited to being a signal that has been single-modulated and double-modulated as above. For example, a communication apparatus according to the embodiments may also generate a transmit signal in the form of a signal in which processing commands are binary-coded (i.e., a single-modulated signal). The scale of circuitry in a circuit for generating a transmit signal is still smaller than that of a PLC-based communication device, even in the case of generating a transmit signal in the form of a signal in which processing commands are binary-coded (i.e., a single-modulated signal). Thus, it is possible to reduce the costs related to the realization of a communication method according to the embodiments more than in the case of using PLC, even in the case of generating a transmit signal in the form of a signal in which processing commands are binary-coded (i.e., a single-modulated signal).

Hereinafter, an exemplary case will be described in which a communication apparatus according to the embodiments generates a transmit signal according to the embodiments in the form of a signal that has been modulated similarly to a signal generated during infrared communication.

### (2) Transmitting Process

A communication apparatus according to the embodiments modulates a transmit signal generated in the above process (1) (signal generating process) onto a carrier signal at the carrier frequency, and transmits the modulated carrier signal via a power line (this corresponds to triple modulation).

More specifically, a communication apparatus according to the embodiments may subject a transmit signal to ASK modulation at a carrier frequency such as 13.56 MHz and transmit the result as the carrier signal, for example. However, the modulation format in a transmitting process according to the embodiments is not limited to ASK modulation. For example, it is also possible for a communication apparatus according to the embodiments to apply another modulation format such as phase-shift keying (PSK).

An example of a signal generated and transmitted by a communication apparatus according to the embodiments by a process in accordance with a communication method according to the embodiments will now be illustrated.

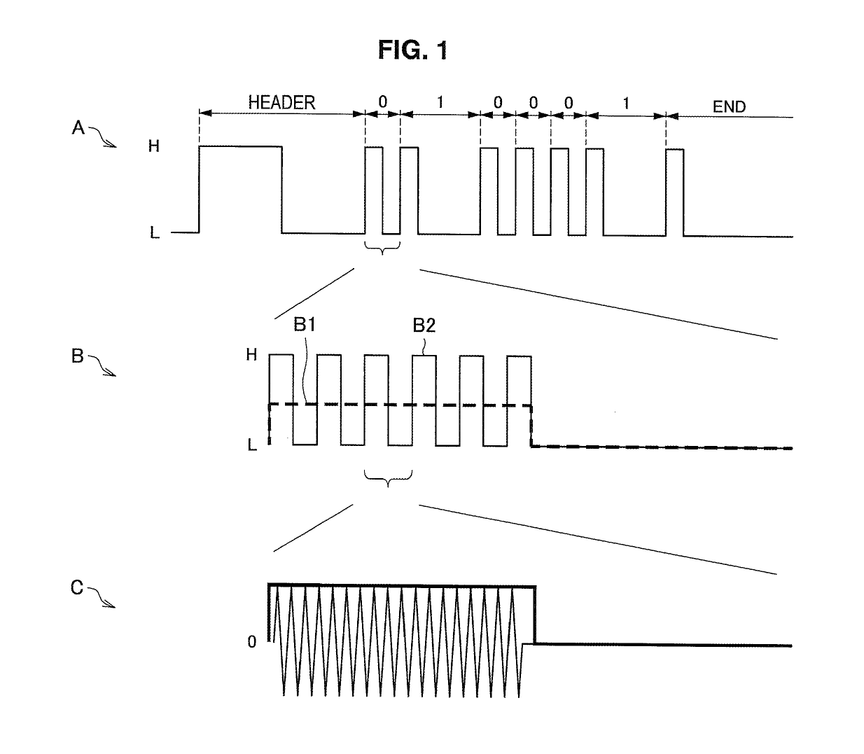

FIG. 1 illustrates an example of a signal generated and transmitted by a process in accordance with a communication method for a communication apparatus according to the embodiments. Herein, FIG. 1 illustrates an example of a signal for the case in which a communication apparatus according to the embodiments generates a transmit signal according to the embodiments in the form of a signal that has been modulated similarly to a signal generated during infrared communication. FIG. 1A illustrates an example of single modulation in the above process (1) (signal generating process), while FIG. 1B illustrates an example of double modulation in the above process (1) (signal generating process). Meanwhile, FIG. 1C illustrates an example of triple modulation in the above process (2) (transmitting process).

A communication apparatus according to the embodiments encodes processing commands in binary using pulse position modulation. (See FIG. 1A. This corresponds to single modulation.) FIG. 1A illustrates an example in which processing commands are expressed as sequences of 0s and 1s, similarly to infrared communication.

After encoding processing commands in binary, a communication apparatus according to the embodiments subjects the binary-coded signal (B1 illustrated in FIG. 1B) to ASK modulation at a frequency that is lower than the carrier frequency, such as 38 kHz to 40 kHz. (See B2 in FIG. 1B. This corresponds to double modulation).

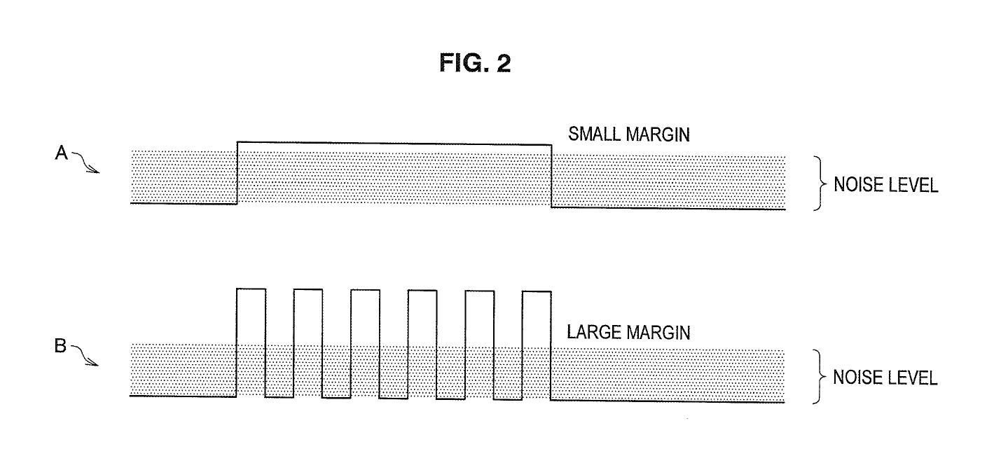

The significance of conducting double modulation when a communication apparatus according to the present embodiment generates a transmit signal will now be illustrated. FIG. 2 illustrates the significance of conducting double modulation when a communication apparatus according to the present embodiment generates a transmit signal. FIG. 2A illustrates a signal corresponding to B1 illustrated in FIG. 1B, while FIG. 2B illustrates a signal corresponding to B2 illustrated in FIG. 1B.

As illustrated in FIG. 2B, conducting ASK modulation makes it possible to further increase the margin against noise with respect to any kind of hypothetical noise source, and thus the effects of such noise may be reduced. Also, as illustrated in FIG. 2B, conducting ASK modulation makes it possible to generate a transmit signal of higher signal strength with less power.

However, as discussed earlier, it is also possible for a communication apparatus according to the embodiments to not conduct the ASK modulation illustrated in FIG. 1B which corresponds to double modulation. Whereas multiple noise sources may potentially exist with infrared communication, a carrier signal according to the embodiments is transmitted via a (wired) power line, and thus the carrier signal is less susceptible to the effects of noise compared to infrared communication. Thus, an electronic apparatus according to the embodiments is able to correctly receive a carrier signal according to the embodiments that has been transmitted from a communication apparatus according to the embodiments, even in the case where the communication apparatus according to the embodiments does not conduct the ASK modulation illustrated in FIG. 1B which corresponds to double modulation.

Referring back to FIG. 1, an example of a signal generated and transmitted by a process in accordance with a communication method for a communication apparatus according to the embodiments will be described. Once a transmit signal is generated, a communication apparatus according to the embodiments transmits a carrier signal by subjecting the transmit signal to ASK modulation at a carrier frequency such as 13.56 MHz. (See FIG. 1C. This corresponds to triple modulation.)

A communication apparatus according to the embodiments is able to transmit processing commands impressed onto a power line by conducting the above process (1) (signal generating process) and process (2) (transmitting process), for example. Consequently, by conducting the above process (1) (signal generating process) and process (2) (transmitting process) as a process in accordance with a communication method according to the embodiments, for example, a communication apparatus according to the embodiments is able to cause an electronic apparatus to conduct a process based on processing commands transmitted via a power line.

Additionally, by conducting the above process (1) (signal generating process) and process (2) (transmitting process), for example, a communication apparatus according to the embodiments is able to realize the following, for example.

A user operates a user apparatus such as a mobile phone or remote control to cause the user apparatus to transmit processing commands to a communication apparatus according to the embodiments, thereby causing an electronic apparatus to conduct a process based on the processing commands through a power line. In other words, the user is able to cause an electronic apparatus to conduct a process based on processing commands without pointing a remote control at the electronic apparatus as with infrared remote controls in the past, for example.

Automation linking multiple electronic apparatus is realized by operating multiple electronic apparatus via a communication apparatus according to the embodiments. For example, it is possible to link the operation of multiple electronic apparatus with processing commands such as “if the user enters input related to watching a movie, power on the TV, recorder, and surround sound speakers, and darken the lights.”

Also, as discussed earlier, since it is possible with a communication apparatus according to the embodiments to make the scale of circuitry in a circuit for generating a transmit signal smaller than that of a PLC-based communication device, size restrictions can be further relaxed compared to the case of using PLC. Moreover, with a communication apparatus according to the embodiments, it is possible to reduce the costs related to realizing a communication method according to the embodiments more than in the case of using PLC.

Note that a process in accordance with a communication method for a communication apparatus according to the embodiments is not limited to the above process (1) (signal generating process) and process (2) (transmitting process). A communication apparatus according to the embodiments may also communicate via a power line with an external apparatus connected in a wired manner by a power line (hereinafter referred to as a “connected external apparatus” in some cases), and may also cause power to be selectively transmitted to a connected external apparatus.

More specifically, a communication apparatus according to the embodiments may, for example, communicate with a connected external apparatus via a power line, and from the connected external apparatus acquire identification information indicating a connected external apparatus (an identification information acquiring process). Additionally, a communication apparatus according to the embodiments may, for example, identify a connected external apparatus on the basis of acquired connected external apparatus (a identifying process). Then, a communication apparatus according to the embodiments may, for example, cause power to be selectively transmitted to the specified connected external apparatus (a power controlling process).

### (3) Identification Information Acquiring Process

As above, a communication apparatus according to the embodiments communicates with a connected external apparatus via a power line, and from the connected external apparatus acquires identification information indicating a connected external apparatus.

Herein, identification information according to the embodiments refers to information which may be used to identify a connected external apparatus. Potential identification information according to the embodiments includes data indicating an identification number unique to the connected external apparatus, data indicating the type of connected external apparatus (such as data indicating the manufacturer or serial number), and power waveform data indicating power waveforms when the connected external apparatus is in use (when driving the connected external apparatus), for example. However, identification information according to the embodiments is not limited to the above examples insofar as it is information which may be used to identify a connected external apparatus.

As discussed earlier, using PLC for communication via a power line carries the risk of increases in the cost of the apparatus that communicates, and in addition, the risk that restrictions may be imposed on the size of the apparatus that communicates.

Thus, a communication apparatus according to the embodiments uses a technique that differs from PLC to communicate via a power line with a connected external apparatus later discussed, such as an electronic apparatus according to the embodiments or a relay node according to the embodiments. Hereinafter, power line communication according to the embodiments that is conducted between a communication apparatus according to the embodiments and a connected external apparatus according to the embodiments will be described.

### (Power Line Communication According to the Embodiments)

Power line communication is conducted between a communication apparatus and a connected external apparatus according to the embodiments by applying wireless communication technology such as NFC-based technology or RFID technology to wired communication, for example. Herein, power line communication according to the embodiments includes communication conducted with the terminals of the respective apparatus in contact (referred to as contact communication), and communication conducted with the terminals of the respective apparatus joined in a wired manner, for example.

A communication apparatus according to the embodiments is equipped with a high-frequency signal generator (discussed later) that generates high-frequency signals, for example, and transmits high-frequency signals to a connected external apparatus. In other words, a communication apparatus according to the embodiments may have what are called reader/writer functions, for example.

Also, a connected external apparatus according to the embodiments may communicate with an external apparatus such as a communication apparatus according to the embodiments, for example, by conducting load modulation on the basis of a signal transmitted from that external apparatus. For example, in the case of receiving a high-frequency signal transmitted from a communication apparatus according to the embodiments, a connected external apparatus according to the embodiments may transmit a high-frequency signal by driving itself with power obtained from the received high-frequency signal and conducting load modulation on the basis of the results of processing the received high-frequency signal.

By having a communication apparatus according to the embodiments and a connected external apparatus according to the embodiments respectively conduct processes like the above, for example, power line communication according to the embodiments is realized between the communication apparatus according to the embodiments and the connected external apparatus according to the embodiments. An exemplary configuration for realizing power line communication according to the embodiments will be discussed later.

Herein, a high-frequency signal according to the embodiments may include high-frequency signals used for RFID, and high-frequency signals used for contactless communication, for example. For example, various frequencies such as 130 kHz to 135 kHz, 13.56 MHz, 56 MHz, 433 MHz, 954.2 MHz, 954.8 MHz, 2441.75 MHz, and 2448.875 MHz may be cited as examples of frequencies for a high-frequency signal, but the frequency of a high-frequency signal according to the embodiments is not limited to the above. In addition, the frequency of a high-frequency signal according to the embodiments may be the same frequency as the frequency of a carrier signal according to the embodiments, for example, but may also be a different frequency.

In addition, since the scale of circuitry is extremely small compared to that of devices such as existing PLC modems, it is possible to miniaturize a communication device using wireless communication technology such as NFC-based technology down to the size of an IC chip, for example. Also, since mobile phones equipped with an IC card or IC chip and other such apparatus able to communicate using wireless communication technology such as NFC-based technology are becoming increasingly prevalent, communication devices using wireless communication technology such as NFC-based technology and RFID technology are cheap compared to existing PLC modems.

Furthermore, by applying wireless communication technology such as NFC-based technology and RFID technology to wired communication, an electronic apparatus according to the embodiments is able to drive itself with power obtained from a high-frequency signal received via a power line, and transmit stored information by conducting load modulation. In other words, in a communication system including a communication apparatus according to the embodiments and an electronic apparatus according to the embodiments, the electronic apparatus according to the embodiments is able to communicate in a wired manner even without being equipped with a separate power circuit for communicating. Also, an electronic apparatus according to the embodiments is able to transmit stored information by conducting load modulation, even without accepting a signal corresponding to user operations (i.e., a signal indicating user instructions) as input, for example.

Consequently, by using wireless communication technology such as NFC-based technology and RFID technology, it is possible to realize power line communication that enables reduced costs, relaxed restrictions on the size of a communication device, and reduced power consumption compared to the case of using power line communication of the past such as existing PLC, for example.

With power line communication according to the embodiments as above, a communication apparatus according to the embodiments communicates with a connected external apparatus via a power line and acquires identification information form the connected external apparatus, for example. More specifically, a communication apparatus according to the embodiments transmits, via a power line, a high-frequency signal containing an identification information transmit request that requests the transmission of identification information, for example. The communication apparatus according to the embodiments then acquires identification information transmitted by load modulation conducted in the connected external apparatus on the basis of the identification information transmit request.

### (4) Identifying Process

A communication apparatus according to the embodiments specifies a connected external apparatus on the basis of identification information acquired by the above process (3) (identification information acquiring process).

Herein, a communication apparatus according to the embodiments may identify a connected external apparatus from the acquired identification information itself, for example, but may also identify a connected external apparatus by searching a database on the basis of the acquired identification information. Additionally, it is also possible for a communication apparatus according to the embodiments to communicate with an external apparatus such as a server, and identify the connected external apparatus corresponding to the acquired identification information in conjunction with the external apparatus.

However, the identifying process in a communication apparatus according to the embodiments is not limited to the above. For example, a communication apparatus according to the embodiments may also authenticate a connected external apparatus (such as an electronic apparatus according to the embodiments or a relay node according to the embodiments, for example) on the basis of identification information acquired by the above process (3) (identification information acquiring process). In the case of conducting authentication, a communication apparatus according to the embodiments may take a correctly authenticated connected external apparatus to be the identified connected external apparatus, for example.

A communication apparatus according to the embodiments may authenticate a connected external apparatus on the basis of whether or not identification information corresponding to identification information acquired from the connected external apparatus is stored in a database where identification information indicating authenticatable external apparatus is recorded, for example. Herein, the database may be stored in a recording medium such as a storage unit (discussed later) provided in a communication apparatus according to the embodiments, but a communication apparatus according to the embodiments may also acquire the database from an external apparatus such as a server.

### (5) Power Controlling Process

A communication apparatus according to the embodiments causes power to be selectively transmitted to the connected external apparatus identified by the above process (4) (identifying process). A communication apparatus according to the embodiments causes power to be selectively transmitted to a connected external apparatus by putting a power supply unit able to selectively supply power (discussed later), or alternatively, an external apparatus with similar functionality as such a power supply unit (discussed later), into a state enabling the selective transmission of power, for example.

More specifically, in the case of causing power to be transmitted to a connected external apparatus, a communication apparatus according to the embodiments may set a state enabling the transmission of power to the connected external apparatus (first transmission state) by issuing a control signal for supplying power to a power supply unit (discussed later), for example. Also, in the case of not causing power to be transmitted to a connected external apparatus, a communication apparatus according to the embodiments may set a state disabling the transmission of power to the connected external apparatus (second transmission state) by issuing a control signal for not supplying power to a power supply unit (discussed later), for example.

However, the power controlling process in a communication apparatus according to the embodiments is not limited to the above. For example, a communication apparatus according to the embodiments may also analyze respective usage trends for connected electronic apparatus and automatically put electronic apparatus into a state enabling the supply of power in the form of a standby state during time periods with high usage frequency. Automatically putting electronic apparatus into a state enabling the supply of power as above may potentially shorten the boot-up times of electronic apparatus. Meanwhile, it is also possible for a communication apparatus according to the embodiments to power off electronic apparatus with the above process (1) (signal generating process) and the process (2) (transmitting process) during time periods with low usage frequency to further reduce standby power in electronic apparatus (i.e., save power) by putting electronic apparatus into a state disabling the supply of power.

A communication apparatus according to the embodiments may additionally conduct the above processes from (3) (identification information acquiring process) to (5) (power controlling process) as part of a process in accordance with a communication method according to the embodiments, for example. By additionally conducting the above processes from (3) (identification information acquiring process) to (5) (power controlling process), a communication apparatus according to the embodiments is able to control the supply of power to connected external apparatus.

Also, by having a communication apparatus according to the embodiments conduct the above processes from (1) (signal generating process) to (5) (power controlling process) as a process in accordance with a communication method according to the embodiments, for example, a communication apparatus according to the embodiments may potentially reduce standby power in an electronic apparatus according to the embodiments later discussed. Hereinafter, a process in accordance with a communication method for a communication apparatus according to the embodiments that enables a potential reduction of standby power in an electronic apparatus according to the embodiments will be described more specifically.

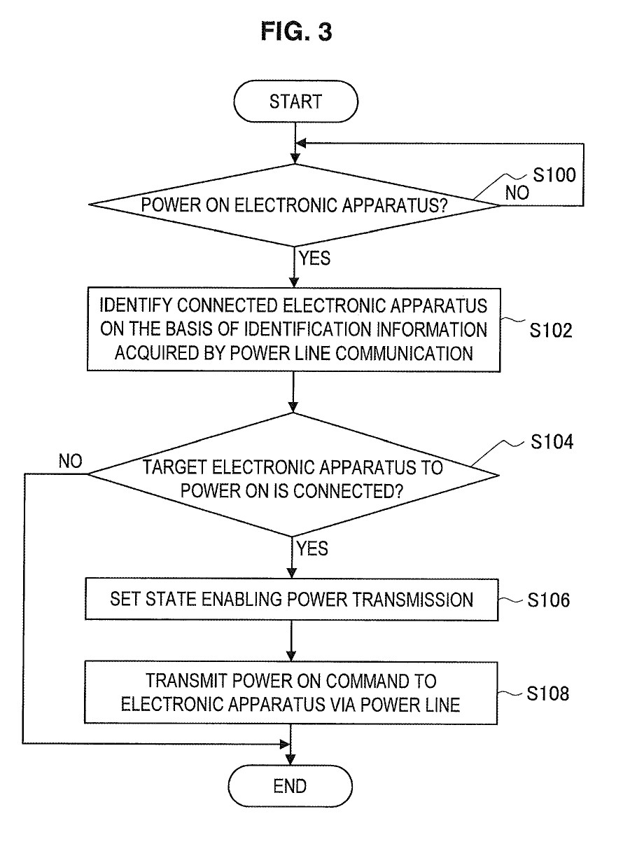

FIG. 3 is a flowchart illustrating an example of a process in accordance with a communication method for a communication apparatus according to the embodiments. FIG. 3 illustrates an example of a process for the case where a communication apparatus according to the embodiments powers on an electronic apparatus according to the embodiments. Herein, the process in step S102 illustrated in FIG. 3 corresponds to the above process (3) (identification information acquiring process) and (4) (identifying process), while steps S104 and S106 illustrated in FIG. 3 correspond to the above process (5) (power controlling process). Also, the process in step S108 illustrated in FIG. 3 corresponds to the above process (1) (signal generating process) and (2) (transmitting process).

A communication apparatus according to the embodiments determines whether or not to power on an electronic apparatus according to the embodiments (S100). The communication apparatus according to the embodiments conducts the process in step S100 on the basis of, for example, an operation signal based on user operations issued from an operable unit (discussed later), or an external operation signal based on user operations transmitted from an external operable device such as a remote control, for example. However, the process in step S100 in a communication apparatus according to the embodiments is not limited to the above. For example, a communication apparatus according to the embodiments may also determine to power on an electronic apparatus according to the embodiments in the case where a preset condition is satisfied.

In the case where it is not determined in step S100 to power on an electronic apparatus according to the embodiments, the communication apparatus according to the embodiments does not advance the process until it is determined to power on an electronic apparatus according to the embodiments.

Meanwhile, in the case where it is determined in step S100 to power on an electronic apparatus according to the embodiments, the communication apparatus according to the embodiments identifies electronic apparatus according to the embodiments connected via a power line on the basis of identification information acquired by power line communication according to the embodiments (S102). Herein, the communication apparatus according to the embodiments may, for example, transmit a high-frequency signal containing an identification information transmit request and acquire, via a power line, identification information transmitted by load modulation conducted in electronic apparatus according to the embodiments (connected external apparatus) on the basis of the identification information transmit request.

If a connected electronic apparatus according to the embodiments is identified in step S102, the communication apparatus according to the embodiments determines whether or not the target electronic apparatus to power is connected via a power line (S104). For example, in the case of conducting the process in step S100 on the basis of an operation signal or an external operation signal, the communication apparatus according to the embodiments determines that the target electronic apparatus to power on is connected when an electronic apparatus that matches the electronic apparatus indicated by identification information contained in the operation signal, etc. exists among the identified electronic apparatus according to the embodiments. As another example, in the case of conducting the process in step S100 on the basis of a preset condition, the communication apparatus according to the embodiments determines that the target electronic apparatus to power on is connected when an electronic apparatus corresponding to the condition exists among the identified electronic apparatus according to the embodiments.

In the case where it is not determined in step S104 that the target electronic apparatus to power on is connected, the communication apparatus according to the embodiments ends the process in accordance with a communication method according to the embodiments. Furthermore, the communication apparatus according to the embodiments may also issue a notification to the user of the communication apparatus according to the embodiments indicating that the target electronic apparatus to power on is not connected, for example. Herein, a notification method according to the embodiments may include methods that appeal to the user's senses, such as visual notification methods using elements such as text, an image, or a blinking light, or auditory notification methods using audio (the term audio herein taken to include sounds such as music and beep tones, for example, and used similarly in this sense hereinafter).

Meanwhile, in the case where it is determined in step S104 that the target electronic apparatus to power on is connected, the communication apparatus according to the embodiments puts the target electronic apparatus to power on in a state enabling the transmission of power (S106). The communication apparatus according to the embodiments conducts the process in step S106 by issuing a control signal for supplying power to a power supply unit (discussed later) corresponding to the target electronic apparatus to power on, for example.

When the process in step S106 is conducted, the communication apparatus according to the embodiments transmits, via a power line, a power on command for executing processing related to powering on (being one example of a processing command) to the target electronic apparatus to power on (S108). The communication apparatus according to the embodiments conducts the process in step S108 by transmitting a carrier signal according to the embodiments containing a power on command via a power line.

The communication apparatus according to the embodiments powers on a target electronic apparatus to power on by conducting the process illustrated in FIG. 3, for example, as a process in accordance with a communication method for a communication apparatus according to the embodiments.

In the case of conducting the process illustrated in FIG. 3, the communication apparatus according to the embodiments puts the electronic apparatus into a state enabling the transmission of power after first identifying the target electronic apparatus to power on. Additionally, the communication apparatus according to the embodiments identifies the target electronic apparatus to power on by acquiring identification information from electronic apparatus according to the embodiments through power line communication according to the embodiments.

At this point, an electronic apparatus may be unable to communicate when the electronic apparatus is not supplied with power in the case of acquiring identification information from electronic apparatus through power line communication of the related art using existing PLC or wireless communication such as infrared communication, for example. For this reason, in the case of acquiring identification information from electronic apparatus through power line communication of the related art using existing PLC or wireless communication such as infrared communication, for example, some degree of power may be supplied to electronic apparatus, and thus some degree of standby power may be consumed by electronic apparatus. In contrast, with power line communication according to the embodiments, it is possible for an electronic apparatus according to the embodiments to drive itself with power obtained from a high-frequency signal received via a power line, and transmit stored information by conducting load modulation. Thus, by conducting power line communication according to the embodiments, it is possible to set the standby power to 0 (zero) in an electronic apparatus according to the embodiments.

Consequently, by conducting the process illustrated in FIG. 3, for example, a communication apparatus according to the embodiments is able to power on a target electronic apparatus to power on while potentially reducing standby power in electronic apparatus according to the embodiments.

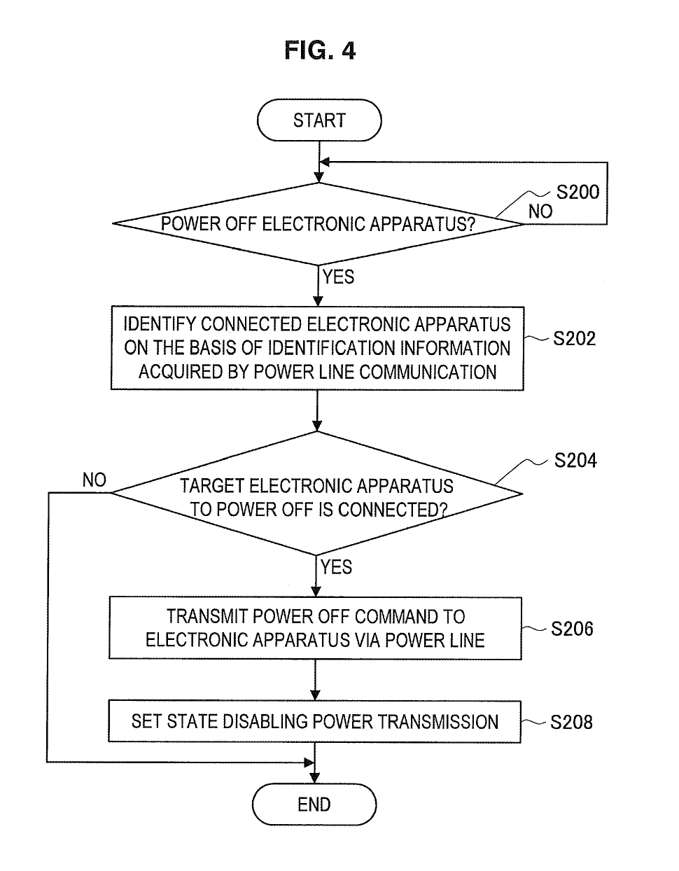

Note that a process in accordance with a communication method for a communication apparatus according to the embodiments that enables a potential reduction of standby power in an electronic apparatus according to the embodiments is not limited to the process illustrated in FIG. 3. FIG. 4 is a flowchart illustrating another example of a process in accordance with a communication method for a communication apparatus according to the embodiments. FIG. 4 illustrates an example of a process for the case where a communication apparatus according to the embodiments powers off an electronic apparatus according to the embodiments. Herein, the process in step S202 illustrated in FIG. 4 corresponds to the above process (3) (identification information acquiring process) and (4) (identifying process), while steps S204 and S206 illustrated in FIG. 4 correspond to the above process (5) (power controlling process). Also, the process in step S208 illustrated in FIG. 4 corresponds to the above process (1) (signal generating process) and (2) (transmitting process).

A communication apparatus according to the embodiments determines whether or not to power off an electronic apparatus according to the embodiments (S200). The communication apparatus according to the embodiments conducts the process in step S200 on the basis of, for example, an operation signal based on user operations issued from an operable unit (discussed later), or an external operation signal based on user operations transmitted from an external operable device such as a remote control, for example. However, the process in step S200 in a communication apparatus according to the embodiments is not limited to the above. For example, a communication apparatus according to the embodiments may also determine to power off an electronic apparatus according to the embodiments in the case where a preset condition is satisfied.

In the case where it is not determined in step S200 to power off an electronic apparatus according to the embodiments, the communication apparatus according to the embodiments does not advance the process until it is determined to power off an electronic apparatus according to the embodiments.

Meanwhile, in the case where it is determined in step S200 to power off an electronic apparatus according to the embodiments, the communication apparatus according to the embodiments identifies electronic apparatus according to the embodiments connected via a power line on the basis of identification information acquired by power line communication according to the embodiments (S202), similarly to step S102 of FIG. 3.

If a connected electronic apparatus according to the embodiments is identified in step S202, the communication apparatus according to the embodiments determines whether or not the target electronic apparatus to power off is connected via a power line (S204). For example, in the case of conducting the process in step S200 on the basis of an operation signal or an external operation signal, the communication apparatus according to the embodiments determines that the target electronic apparatus to power off is connected when an electronic apparatus that matches the electronic apparatus indicated by identification information contained in the operation signal, etc. exists among the identified electronic apparatus according to the embodiments. As another example, in the case of conducting the process in step S200 on the basis of a preset condition, the communication apparatus according to the embodiments determines that the target electronic apparatus to power off is connected when an electronic apparatus corresponding to the condition exists among the identified electronic apparatus according to the embodiments.

In the case where it is not determined in step S204 that the target electronic apparatus to power off is connected, the communication apparatus according to the embodiments ends the process in accordance with a communication method according to the embodiments. Furthermore, the communication apparatus according to the embodiments may also issue a notification to the user of the communication apparatus according to the embodiments indicating that the target electronic apparatus to power off is not connected, for example. Herein, a notification method according to the embodiments may include methods that appeal to the user's senses, such as visual notification methods or auditory notification methods, for example.

Meanwhile, in the case where it is determined in step S204 that the target electronic apparatus to power off is connected, the communication apparatus according to the embodiments transmits, via a power line, a power off command for executing processing related to powering off (being one example of a processing command) to the target electronic apparatus to power off (S206). The communication apparatus according to the embodiments conducts the process in step S206 by transmitting a carrier signal according to the embodiments containing a power off command via a power line.

When the process in step S206 is conducted, the communication apparatus according to the embodiments puts the target electronic apparatus to power off into a state disabling the transmission of power (S208). The communication apparatus according to the embodiments conducts the process in step S208 by issuing a control signal for not supplying power to a power supply unit (discussed later) corresponding to the target electronic apparatus to power off, for example.

The communication apparatus according to the embodiments powers off a target electronic apparatus to power off by conducting the process illustrated in FIG. 4, for example, as a process in accordance with a communication method for a communication apparatus according to the embodiments.

In the case of conducting the process illustrated in FIG. 4, the communication apparatus according to the embodiments puts the electronic apparatus into a state disabling the transmission of power after first causing the target electronic apparatus to power off to execute the power off command. In other words, an electronic apparatus according to the embodiments is able to execute the power off command before entering a state disabling the transmission of power. Thus, by having a communication apparatus according to the embodiments execute the process illustrated in FIG. 4, for example, it is possible to avoid an electronic apparatus failure or other undesirable situation which may be caused due to entering a state disabling the transmission of power before a power off command is executed, for example.

Additionally, it is possible for a communication apparatus according to the embodiments to power off an electronic apparatus according to the embodiment even in the case where the electronic apparatus according to the embodiments is in a state of 0 (zero) standby power, as illustrated with reference to FIG. 3, for example. In other words, even if a communication apparatus according to the embodiments puts a target electronic apparatus to power off into a state disabling the transmission of power and the standby power in the electronic apparatus according to the embodiments is made to be 0 (zero), as illustrated with reference to FIG. 4, for example, it is still possible to power on that electronic apparatus once again.

Consequently, by conducting the process illustrated in FIG. 4, for example, a communication apparatus according to the embodiments is able to power off a target electronic apparatus to power off while potentially reducing standby power in electronic apparatus according to the embodiments.

At this point, it may not be feasible to reduce to 0 (zero) the standby power of a state in which an electronic apparatus stands by for processing commands in the case of using power line communication of the related art with existing PLC or wireless communication such as infrared communication, for example. For this reason, in the case of using power line communication of the related art with existing PLC or wireless communication such as infrared communication, the user may feel compelled to pull the plug from the power outlet, for example, in order to save power when not using an electronic apparatus for long periods of time. Moreover, power outlets and plugs are often placed in locations which are hard for the user to reach, such as under a desk, for example. For this reason, in practice the plug often remains connected to a power outlet even when the electronic apparatus is not used for long periods of time, and thus power is consumed needlessly by the electronic apparatus.

In contrast, by having a communication apparatus according to the embodiments conduct the processes illustrated in FIGS. 3 and 4 as discussed above, for example, it is possible to reduce the standby power to 0 (zero) in an electronic apparatus according to the embodiments. Consequently, by conducting the processes illustrated in FIGS. 3 and 4, for example, a communication apparatus according to the embodiments is able to reduce standby power in electronic apparatus compared to the case of using power line communication of the related art with existing PLC or wireless communication such as infrared communication. Furthermore, since it is possible to reduce the standby power to 0 (zero) in an electronic apparatus according to the embodiments without pulling the plug from the power outlet by having a communication apparatus according to the embodiments conduct the processes illustrated in FIGS. 3 and 4 as discussed above, for example, it is also possible to further improve user convenience.

[2] Process in Accordance with Communication Method in Electronic Apparatus According to the Embodiments

An electronic apparatus according to the embodiments receives, via a power line, a carrier signal according to the embodiments transmitted from a communication apparatus according to the embodiments (a receiving process). The electronic apparatus according to the embodiments then executes processing indicated by processing commands corresponding to the received carrier signal (an executing process).

More specifically, an electronic apparatus according to the embodiments identifies processing commands indicated by a transmit signal transmitted from a communication apparatus according to the embodiments by demodulating the received carrier signal according to a procedure that is the reverse of the modulating procedure in the above communication apparatus according to the embodiments. The electronic apparatus according to the embodiments then executes processing on the basis of the identified processing commands.

By conducting the above receiving process and executing process, for example, an electronic apparatus according to the embodiments is able to conduct a process based on processing commands transmitted via a power line.

In addition, an electronic apparatus according to the embodiments may also include functionality for conducting power line communication according to the embodiments, for example. In the case of including power line communication according to the embodiments, an electronic apparatus according to the embodiments may, for example, drive itself with power obtained from a received high-frequency signal when receiving a high-frequency signal transmitted from an external apparatus such as a communication apparatus according to the embodiments. The electronic apparatus according to the embodiments may then transmit a high-frequency signal by conducting load modulation on the basis of the results of processing the received high-frequency signal, for example.

[3] Process in Accordance with Communication Method in Relay Node According to the Embodiments

A relay node according to the embodiments receives, via a power line, a carrier signal according to the embodiments transmitted from a communication apparatus according to the embodiments (a receiving process). The relay node according to the embodiments then transmits a transmit signal corresponding to the received carrier signal to an external apparatus (a relaying process).

More specifically, a relay node according to the embodiments obtains a transmit signal transmitted from a communication apparatus according to the embodiments by demodulating the received carrier signal according to a procedure that is the reverse of the modulating procedure in the above communication apparatus according to the embodiments. Also, a relay node according to the embodiments transmits a transmit signal obtained from the received carrier signal to an external apparatus (such as an electronic apparatus) in a wired or wireless manner via a network (or directly).

As above, a relay node according to the embodiments fulfills the role of relaying, to an external apparatus, a transmit signal contained in a carrier signal transmitted from a communication apparatus according to the embodiments. At this point, the electronic apparatus in which the user wants to induce a process based on processing commands transmitted from a communication apparatus according to the embodiments is not limited to being an electronic apparatus able to conduct a process in accordance with a communication method in an electronic apparatus according to the embodiments discussed earlier (or in other words, an electronic apparatus according to the embodiments). By fulfilling the role of relaying a transmit signal to an external apparatus, a relay node according to the embodiments is able to cause that external apparatus to conduct a process based on processing commands transmitted from a communication apparatus according to the embodiments, even in the hypothetical case where the external apparatus is not an electronic apparatus according to the embodiments.

Meanwhile, a communication device such as a PLC modem is often built into an electronic apparatus in the case of using power line communication of the related art with existing PLC. On the other hand, by using a relay node according to the embodiments, it becomes possible to cause an external apparatus to conduct a process based on processing commands transmitted from a communication apparatus according to the embodiments, even in the case where the external apparatus is not an electronic apparatus according to the embodiments as above.

Consequently, a relay node according to the embodiments is able to cause an electronic apparatus to conduct a process based on processing commands transmitted via a power line.

In addition, with a relay node according to the embodiments, it is possible, for example, to enable a user who desires to operate an electronic apparatus via a power line to additionally purchase a separate accessory (a relay node according to the embodiments), and thereby add functionality for operating an electronic apparatus via a power line to an existing electronic apparatus.

In addition, a relay node according to the embodiments may also include functionality for conducting power line communication according to the embodiments, for example. In the case of including power line communication according to the embodiments, a relay node according to the embodiments may, for example, drive itself with power obtained from a received high-frequency signal when receiving a high-frequency signal transmitted from an external apparatus such as a communication apparatus according to the embodiments. The relay node according to the embodiments may then transmit a high-frequency signal by conducting load modulation on the basis of the results of processing the received high-frequency signal, for example.

Hereinafter, exemplary configurations of a communication apparatus according to the embodiments, an electronic apparatus according to the embodiments, and a relay node according to the embodiments which are able to conduct processes in accordance with a communication method according to the embodiments as discussed above will be described.

### Communication Apparatus and Electronic Apparatus According to the Embodiments

### [1] First Embodiment

An exemplary configuration of a communication apparatus able to conduct above process (1) (signal generating process) and process (2) (transmitting process) in accordance with a communication method for a communication apparatus according to the embodiments will now be described as a communication apparatus according to the first embodiment. Also, an exemplary configuration of an electronic apparatus able to conduct above receiving process and the above executing process in accordance with a communication method in an electronic apparatus according to the embodiments will now be described as an electronic apparatus according to the first embodiment.

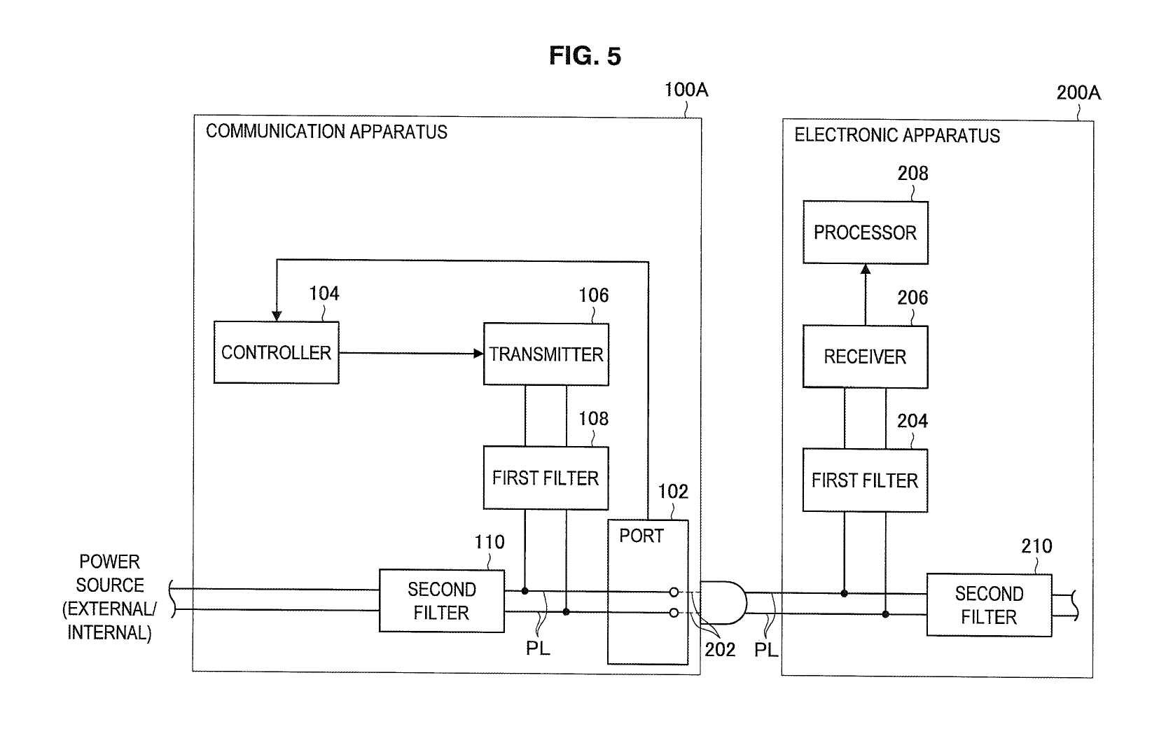

FIG. 5 illustrates exemplary configurations of a communication apparatus 100A according to the first embodiment and an electronic apparatus 200A according to the first embodiment.

### (1-1) Exemplary Configuration of Communication Apparatus 100A According to the First Embodiment

The communication apparatus 100A is equipped with a port 102, a controller 104, a transmitter 106, a first filter 108 (communication filter), and a second filter 110, for example.

The communication apparatus 100A may also be equipped with read-only memory (ROM; not illustrated), random access memory (RAM; not illustrated), a storage unit (not illustrated), a display unit (not illustrated), an operable unit (not illustrated) that is operable by the user, and a communication unit (not illustrated), for example. Respective components in the communication apparatus 100A may be connected to each other by a bus that acts as a data transmission line, for example.

Herein, the ROM (not illustrated) stores programs used by the controller 104 and control data such as computational parameters. The RAM (not illustrated) temporarily stores information such as programs executed by the controller 104.

The storage unit (not illustrated) stores various data such as processing command data and applications, for example. Potential examples of the storage unit (not illustrated) include magnetic recording media such as a hard disk, as well as non-volatile memory such as electrically erasable and programmable read-only memory (EEPROM), flash memory, magnetoresistive random access memory (MRAM), ferroelectric random access memory (FeRAM), and phase-change random access memory (PRAM). Additionally, the storage unit (not illustrated) may also be removable from the communication apparatus 100A.

The display unit (not illustrated) provided in the communication apparatus 100A displays various information (such as images and/or text, for example) on a display screen. Potential screens that may be displayed on the display screen of the display unit (not illustrated) include user interface screens for causing the communication apparatus 100A to behave in a desired way, for example. Examples of the display unit (not illustrated) herein may include display devices such as liquid crystal displays (LCDs) and organic electroluminescent (EL) displays, also referred to as organic light-emitting diode (OLED) displays. The communication apparatus 100A may also be configured such that the display unit (not illustrated) is a touchscreen, for example. In this case, the display unit (not illustrated) functions as an operable display unit capable of both accepting user operations and displaying information.

Note that it is also possible for a communication apparatus 100A to communicate with an external terminal via a network (or directly) and cause the above user interface screens and various information to be displayed on a display screen of the external terminal, irrespective of whether or not the communication apparatus 100A itself is equipped with a display unit (not illustrated). For example, in the above case of an external terminal (such as a mobile communication apparatus or remote control, for example) possessed by the user of the above communication apparatus 100A, the user may operate his or her own external terminal and cause the communication apparatus 100A to conduct a desired process, and in addition, use the external terminal to check information transmitted from the communication apparatus 100A. Thus, in the above case, user convenience is potentially improved even when it is not easy for the user to directly operate the communication apparatus 100A or view information displayed on the display unit (not illustrated), such as when the communication apparatus 100A is installed under a desk, for example.

The operable unit (not illustrated) may include buttons, directional keys, a jog dial or other rotary selector, or some combination thereof, for example. Note that the communication apparatus 100A may also be connected to external operable devices, such as operable input devices (a keyboard and mouse, for example) which act as external apparatus for the communication apparatus 100A.

The communication unit (not illustrated) provided in the communication apparatus 100A fulfills the role of communicating with a server or other external apparatus in a wired or wireless manner via a network (or directly). The communication unit (not illustrated) herein may be a communication antenna and radio-frequency (RF) circuit (wireless communication), an IEEE 802.15.1 port and transceiver circuit (wireless communication), an IEEE 802.11b port and transceiver circuit (wireless communication), or a local area network (LAN) port and transceiver circuit (wired communication), for example. In addition, potential networks according to the embodiments may include wired networks such as a LAN or a wide area network (WAN), wireless networks such as a wireless local area network (WLAN), or an internet that uses a communication protocol such as the Transmission Control Protocol and Internet Protocol (TCP/IP), for example.

The port 102 connects a power line PL, on which power is transferred, to an external apparatus. The port 102 may also be provided with a connection support member that helps to maintain a connected state with an external apparatus connected thereto. A power line according to the embodiments herein may include alternating current (AC) power lines in which current flows alternating at a given frequency such as 50 Hz or 60 Hz, and direct current (DC) power lines in which current flows directly, for example. Additionally, a connection support member according to the embodiments may be a magnet, for example. Hereinafter, the case of an AC power line PL in which current flows alternating at a given frequency will be described as an example.

More specifically, the port 102 may include a terminal connected to the power line PL, for example. Meanwhile, a port 202 provided in the electronic apparatus 200A may include a terminal connected to the power line PL (corresponding to an external power line from the perspective of the communication apparatus 100A), for example. The communication apparatus 100A and the electronic apparatus 200A (corresponding to an external apparatus from the perspective of the communication apparatus 100A) are thus connected by establishing an electrical connection between the terminal included in the port 102 and the terminal included in the port 202. Herein, an “electrical connection between the terminal included in the port 102 and the terminal included in the port 202” according to the embodiments refers to the terminals included in the ports of the respective apparatus being in contact with each other, or the terminals included in the ports of the respective apparatus being joined in a wired manner, for example. Note that the port 202 may also be provided with a connection support member that helps to maintain a connected state with an external apparatus connected thereto, similarly to the port 102 provided in the communication apparatus 100A.

In addition, the port 102 may also include, for example, functionality for detecting a change in the connection state of an external apparatus (i.e., a change from a disconnected state to a connected state, or a change from a connected state to a disconnected state), and issuing to the controller 104 a detection signal that indicates the detected change (a detection result). In this case, the port 102 may be provided with a switch that detects the physical connection state of an external apparatus, and may issue a detection signal to the controller 104 when the state of the switch changes, for example. Note that in some cases the port 102 may also issue a detection signal to the transmitter 106 or to a power line communication line discussed later, such as in the case of a configuration that includes functionality for the transmitter 106 to transmit a carrier signal in response to the issuing of a detection signal, or in the case of a configuration that includes functionality for the power line communication unit discussed later to transmit a high-frequency signal in response to the issuing of a detection signal, for example.

The controller 104 is realized by a microprocessing unit (MPU) or an integrated circuit in which various processor circuits are integrated, and controls the components of the communication apparatus 100A. More specifically, in the case where the communication unit (not illustrated) receives processing command data, for example, the controller 104 may cause the transmitter 106 to transmit a carrier signal according to the embodiments if a preset condition is satisfied. In other words, in the communication apparatus 100A, the controller 104 fulfills a role as a transmit controller that controls the transmission of carrier signals containing processing commands, or in other words, fulfills the role of controlling the above process (1) (signal generating process) and the above process (2) (transmitting process) in accordance with a communication method according to the embodiments, for example.

The transmitter 106 fulfills the leading role of conducting the above process (1) (signal generating process) and the above process (2) (transmitting process) in accordance with a communication method according to the embodiments, and transmits, via a power line, a carrier signal that has been modulated at a carrier frequency by a transmit signal in which processing commands are encoded. An exemplary configuration of the transmitter 106 will be discussed later.

The first filter 108 is connected between the transmitter 106 and the power line PL, and fulfills the role of filtering signals transmitted along the power line PL. More specifically, the first filter 108 includes functionality for at least blocking signals at the frequency of the power supplied to a connected external apparatus such as the electronic apparatus 200A via a power line, while not blocking signals at the carrier frequency (i.e., carrier signals), from among the signals transmitted along the power line PL. By equipping the communication apparatus 100A with the first filter 108, potentially noise-inducing signals at the power frequency are not transmitted to the transmitter 106. An exemplary configuration of the first filter 108 will be discussed later.

The second filter 110 is provided on the power line PL between the port 102 and a power source, and fulfills the role of filtering signals which may be transmitted from the port 102 side of the second filter 110. Herein, a power source according to the embodiments may include an external power source such as an electric utility, or an internal power source such as a battery, for example.

More specifically, the second filter 110 at least includes functionality for blocking carrier signals transmitted by the transmitter 106, while not blocking signals at the frequency of the power supplied to the connected external apparatus. By providing the second filter 110, the communication apparatus 100A is able to block carrier signals transmitted via a power line as well as noise components such as those which may be transmitted from the connected external apparatus, for example. In other words, the second filter 110 fulfills the role of a power splitter. An exemplary configuration of the second filter 110 will be discussed later.

With the configuration illustrated in FIG. 5, for example, the communication apparatus 100A conducts the above process (1) (signal generating process) and the above process (2) (transmitting process) in accordance with a communication method for a communication apparatus according to the embodiments. The respective configurations of the transmitter 106, the first filter 108, and the second filter 110 will now be described more specifically.

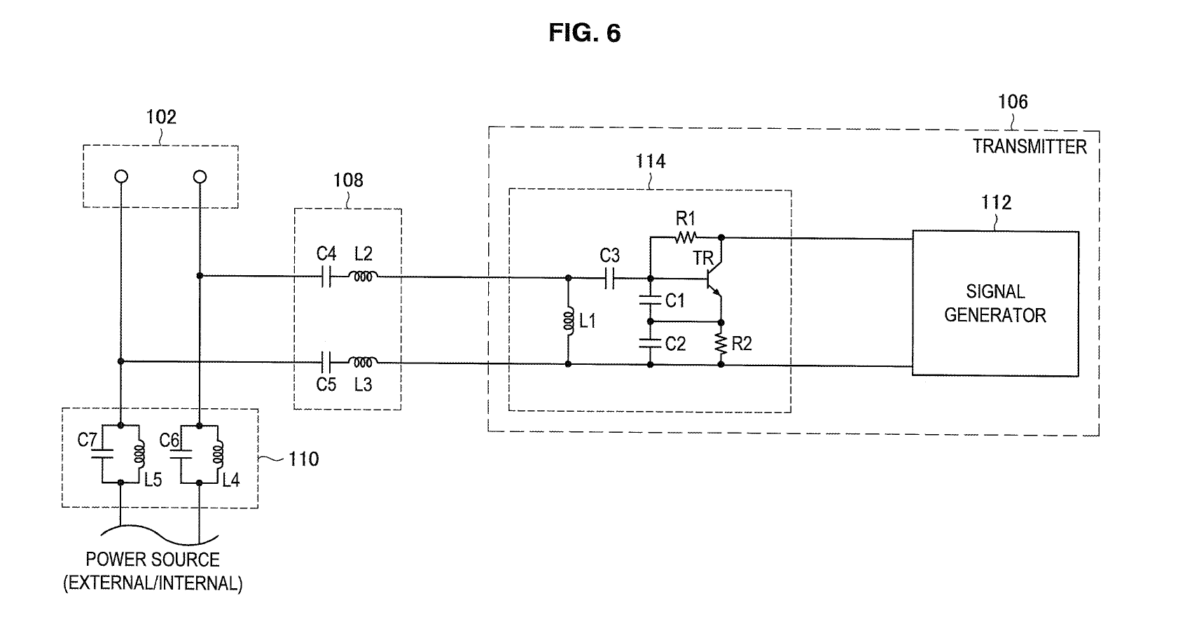

FIG. 6 illustrates exemplary configurations of the transmitter 106, the first filter 108, and the second filter 110 provided in the communication apparatus 100A according to the first embodiment. Herein, the port 102 is additionally illustrated in FIG. 6.

The transmitter 106 is equipped with a signal generator 112 and a carrier transmitter 114, for example.

The signal generator 112 fulfills the leading role of conducting the above process (1) (signal generating process) and the above process (2) (transmitting process), and generates a transmit signal in which processing commands are encoded. In the case where the communication apparatus 100A generates a transmit signal according to the embodiments in the form of a signal that has been modulated similarly to a signal generated during infrared communication, the signal generator 112 herein may be realized with an infrared module, for example.

However, the signal generator 112 is not limited to being an infrared module. For example, the signal generator 112 may also be realized with an arbitrarily configured circuit able to generate a signal in which processing commands are binary-coded (i.e., a single-modulated signal). It is also possible to realize the signal generator 112 with an arbitrarily configured circuit able to encode processing commands in binary, and in addition, use the binary-coded signal (i.e., a single-modulated signal) to generate a signal that is ASK-modulated at a frequency lower than the carrier frequency (i.e., a double-modulated signal), for example. A recording medium able to store processing command data may also be provided in the signal generator 112.

The carrier transmitter 114 fulfills the leading role of conducting the above process (2) (transmitting process), and transmits, via a power line, a carrier signal that has been modulated at a carrier frequency by a transmit signal generated in the signal generator 112.

Herein, FIG. 6 illustrates an example in which the carrier transmitter 114 is an oscillator circuit realized with a transistor TR, resistors R1 and R2 respectively having given resistances, capacitors C1, C2, and C3 respectively having given capacitances, and an inductor L1 having a given inductance. The resistances of the resistors R1 and R2, the capacitances of the capacitors C1, C2, and C3, and the inductance of the inductor L1 may be values corresponding to the carrier frequency, for example. However, the configuration of the carrier transmitter 114 is not limited to the configuration illustrated in FIG. 6. For example, the carrier transmitter 114 may take an arbitrary configuration able to modulate a carrier at a carrier frequency with a transmit signal generated in the signal generator 112.

By providing the signal generator 112 and the carrier transmitter 114, for example, the transmitter 106 fulfills the leading role of conducting the above process (1) (signal generating process) and the process (2) (transmitting process) in accordance with a communication method according to the embodiments.

The first filter 108 may include a bandpass filter having an inductor L2 and a capacitor C4 connected in series, and a bandpass filter having an inductor L3 and a capacitor C5 connected in series, for example. The inductance values of the inductors L2 and L3 and the capacitance values of the capacitors C4 and C5 may be set according to the frequency of the carrier signal, for example. More specifically, the inductance values of the inductors L2 and L3 and the capacitance values of the capacitors C4 and C5 may be set so as to satisfy the following Eq. 1, for example. Herein, the term f in Eq. 1 represents a carrier signal frequency such as 13.56 MHz, for example.

$$2 π f = \frac{1}{\sqrt{LC}} \qquad ( 1 )$$

With the configuration illustrated in FIG. 6, for example, the first filter 108 fulfills the role of filtering signals transmitted along the power line PL. However, the configuration of the first filter 108 according to the embodiments is not limited to the configuration illustrated in FIG. 6. For example, the first filter 108 may be a high-pass filter or other arbitrarily configured filter able to realize the above-described “blocking signals at the frequency of the power supplied to a connected external apparatus such as the electronic apparatus 200A via a power line, while not blocking signals at the carrier frequency, from among the signals transmitted along the power line PL.”

The second filter 110 may include a band-stop filter having a capacitor C6 and an inductor L4 connected in parallel, and a band-stop filter having a capacitor C7 and an inductor L5 connected in parallel, for example. The capacitance values of the capacitors C6 and C7 and the inductance values of the inductors L4 and L5 may be set according to the frequency of the carrier signal, for example.

With the configuration illustrated in FIG. 6, for example, the second filter 110 fulfills the role of filtering signals which may be transmitted from the port 102 side of the second filter 110. However, the configuration of the second filter 210 according to the embodiments is not limited to the configuration illustrated in FIG. 6. For example, the second filter 110 may also be an arbitrarily configured filter able to block high-frequency signals without blocking signals at the power frequency (such as a low-pass filter, for example).

With the configuration illustrated in FIGS. 5 and 6, for example, the communication apparatus 100A according to the first embodiment is able to conduct the above process (1) (signal generating process) and the above process (2) (transmitting process) in accordance with a communication method for a communication apparatus according to the embodiments. Consequently, with the configuration illustrated in FIGS. 5 and 6, for example, the communication apparatus 100A according to the first embodiment is able to cause an electronic apparatus to conduct a process based on processing commands transmitted via a power line.

Also, as discussed earlier, with a communication apparatus according to the embodiments, it is possible to make the scale of circuitry in a circuit for generating a transmit signal smaller than that of a PLC-based communication device. Moreover, since it is possible to realize the carrier transmitter 114 with an oscillator circuit as illustrated in FIG. 6, for example, the scale of circuitry in the carrier transmitter 114 becomes smaller than that of a PLC-based communication device.

Consequently, since it is possible with the communication apparatus 100A according to the first embodiment to make the scale of circuitry in a circuit for conducting a process in accordance with a communication method according to the embodiments smaller than that of a PLC-based communication device, size restrictions can be further relaxed compared to the case of using PLC. Moreover, with the communication apparatus 100A according to the first embodiment, it is possible to reduce the costs related to realizing a communication method according to the embodiments more than in the case of using PLC.

However, the configuration of the communication apparatus 100A according to the first embodiment is not limited to the configuration illustrated in FIG. 5. For example, a communication apparatus according to the first embodiment may also be equipped with multiple ports. In the case of a configuration equipped with multiple ports, a communication apparatus according to the first embodiment may transmit a carrier signal according to the embodiments to connected external apparatus respectively connected to each port, for example.

In addition, a communication apparatus according to the first embodiment may also be equipped with various sensors that output a detection value regarding a preset condition, such as temperature sensors, humidity sensors, and illumination sensors, for example (these being examples of a detecting device corresponding to a preset condition). By providing a detecting device corresponding to a preset condition, a communication apparatus according to the first embodiment is able to conduct a process in accordance with a communication method according to the embodiments on the basis of a detection value from the detecting device and the preset condition.

A communication apparatus according to the first embodiment may also be equipped with a communication unit that communicates with external apparatus, for example. In the case of providing a communication unit, a communication apparatus according to the first embodiment is able to receive detection data transmitted from a detecting device corresponding to a preset condition given as an external apparatus, and conduct a process in accordance with a communication method according to the embodiments on the basis of a detection value indicated by the received detection data and the preset condition. Also, in the case of providing a communication unit, a communication apparatus according to the first embodiment is able to receive, for example, a power-saving request from a power company, or operation commands based on user operations, for example. Furthermore, in the case of providing a communication unit, it is also possible for a communication apparatus according to the first embodiment to transmit data indicating the state of an electronic apparatus connected via a power line to equipment such as a user terminal or a server, for example.

### (1-2) Exemplary Configuration of Electronic Apparatus 200A According to the First Embodiment

Next, an exemplary configuration of an electronic apparatus 200A according to the first embodiment will be described with reference to FIG. 5 again. The electronic apparatus 200A is equipped with a port 202, a first filter 204 (communication filter), a receiver 206, a processor 208, and a second filter 210, for example.

The electronic apparatus 200A may also be equipped with, for example, a battery (not illustrated) and various devices for realizing functionality included in the electronic apparatus 200A (such as an MPU, various processor circuits, and a driving device; not illustrated), which may be provided downstream to the second filter 210 (i.e., on the side of the second filter 210 opposite the communication apparatus 100A as illustrated in FIG. 5), for example. In other words, the electronic apparatus 200A may be able to charge the above battery (not illustrated) with power supplied via a power line, and in addition, realize functionality included in the electronic apparatus 200A by using such supplied power. For example, in the case where the electronic apparatus 200A is a vehicle such as an electric car, the electronic apparatus 200A may receive a supply of power used to charge an internal battery, and then use power from the battery to drive the wheels. Also, in the case where the electronic apparatus 200A is equipped with a display device able to display images (including moving images and still images) and/or text, the electronic apparatus 200A may receive a supply of power and cause images and text to be displayed on the display screen of the display device.

The first filter 204 is connected between a power line (strictly, the power line PL inside the electronic apparatus 200A) and the receiver 206, and fulfills the role of filtering signals transmitted along the power line. More specifically, the first filter 204 includes functionality for at least blocking signals at the power frequency while not blocking carrier signals from among the signals transmitted along the power line.

By providing the first filter 204, the electronic apparatus 200A does not transmit potentially noise-inducing signals at the power frequency to the receiver 206, thereby making it possible to further improve the reception of a carrier signal transmitted from a communication apparatus according to the embodiments at the receiver 206. An exemplary configuration of the first filter 204 will be discussed later.

The receiver 206 fulfills the leading role of conducting the above receiving process in accordance with a communication method according to the embodiments, and receives, via a power line, a carrier signal according to the embodiments transmitted from a communication apparatus according to the embodiments.

More specifically, the receiver 206 may receive a carrier signal via a power line, and demodulate the received carrier signal according to a procedure that is the reverse of the modulating procedure in the communication apparatus according to the embodiments discussed earlier, for example. By demodulating a carrier signal as above, for example, the electronic apparatus 200A is able to identify processing commands specified by a transmit signal transmitted from a communication apparatus according to the embodiments. The receiver 206 then transmits a signal indicating the processing commands (or processing command data) to the processor 208. Note that the receiver 206 may also demodulate the carrier signal and transmit the transmit signal to the processor 208, for example.

By conducting a process like the above, for example, the receiver 206 receives, via a power line, a carrier signal according to the embodiments transmitted from a communication apparatus according to the embodiments. An exemplary configuration of the receiver 206 will be discussed later.

The processor 208 fulfills the leading role of conducting the above executing process in accordance with a communication method according to the embodiments, and may conduct a process indicated by processing commands corresponding to a received carrier signal on the basis of a signal indicating the processing commands which is transmitted from the receiver 206, for example. Also, in the case where a transmit signal is transmitted from the receiver 206, the processor 208 may demodulate the transmitted transmit signal to identify processing commands, and conduct a process indicated by the identified processing commands, for example. The processor 208 herein may be an MPU or an integrated circuit in which various processor circuits are integrated, for example. The processor 208 may also be a component provided downstream to the second filter 210 (i.e., on the side of the second filter 210 opposite the communication apparatus 100A as illustrated in FIG. 5).

The second filter 210 fulfills the role of filtering signals which may be transmitted from external apparatus such as the communication apparatus 100A via the power line PL. More specifically, the second filter 210 at least includes functionality for blocking carrier signals transmitted by a communication apparatus according to the embodiments, while not blocking signals at the frequency of the power supplied via the power line PL. By providing the second filter 210, the electronic apparatus 200A is able to block carrier signals transmitted via a power line as well as noise components such as those which may be transmitted along a power line, for example. In other words, the second filter 210 fulfills the role of a power splitter, similarly to the second filter 110 provided in the communication apparatus 100A. An exemplary configuration of the second filter 210 will be discussed later.

With the configuration illustrated in FIG. 5, for example, the electronic apparatus 200A conducts the above receiving process and the above executing process in accordance with a communication method for an electronic apparatus according to the embodiments. The respective configurations of the first filter 204, the receiver 206, and the second filter 210 will now be described more specifically.

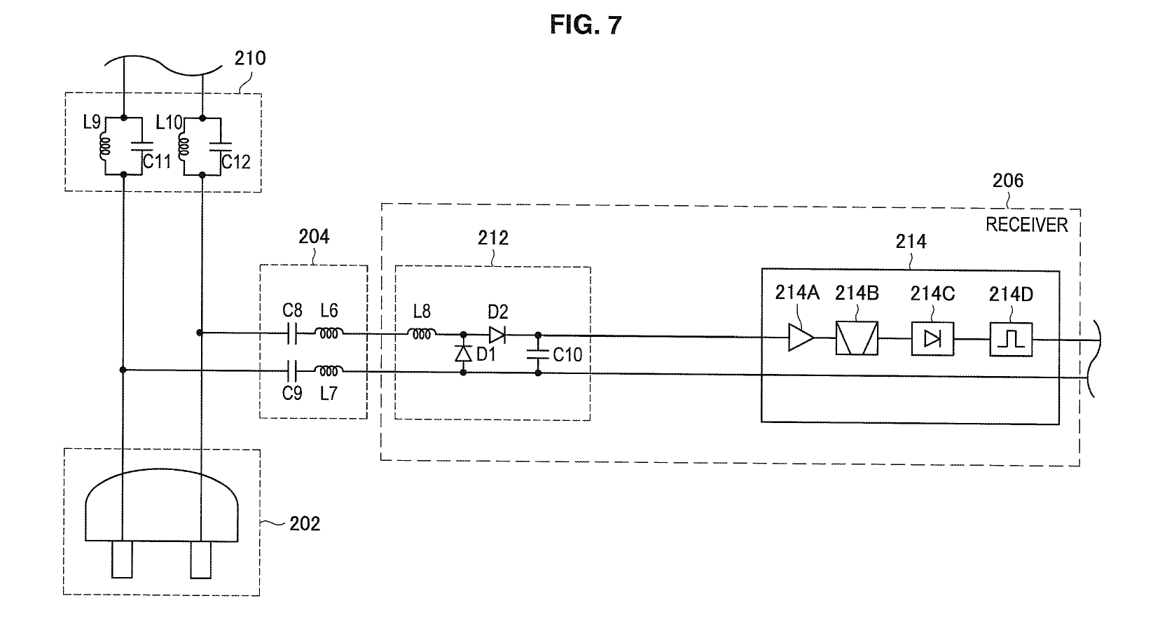

FIG. 7 illustrates exemplary configurations of the first filter 204, the receiver 206, and the second filter 210 provided in the electronic apparatus 200A according to the first embodiment. Herein, FIG. 7 illustrates exemplary configurations of the first filter 204, the receiver 206, and the second filter 210 provided in the electronic apparatus 200A according to the first embodiment for the case in which a communication apparatus according to the embodiments generates a transmit signal according to the embodiments in the form of a signal that has been modulated similarly to a signal generated during infrared communication. Also, the port 202 is additionally illustrated in FIG. 7.

The first filter 204 may include a bandpass filter having an inductor L6 and a capacitor C8 connected in series, and a bandpass filter having an inductor L7 and a capacitor C9 connected in series, for example. The inductance values of the inductors L6 and L7 and the capacitance values of the capacitors C8 and C9 may be set according to the frequency of the carrier signal, for example. More specifically, the inductance values of the inductors L6 and L7 and the capacitance values of the capacitors C8 and C9 may be set so as to satisfy the earlier Eq. 1, for example.

With the configuration illustrated in FIG. 7, for example, the first filter 204 fulfills the role of filtering signals transmitted along the power line PL. However, the configuration of the first filter 204 according to the embodiments is not limited to the configuration illustrated in FIG. 7. For example, it is also possible to realize the first filter 204 with an arbitrarily configured filter such as a high-pass filter, similarly to the first filter 108 provided in the communication apparatus 100A according to the embodiments illustrated in FIG. 5.

The receiver 206 is equipped with a first demodulator 212 and a second demodulator 214, for example.

The first demodulator 212 rectifies a received carrier signal at the carrier frequency. By rectifying the received carrier signal at the carrier frequency, a transmit signal according to the embodiments is obtained. FIG. 7 herein illustrates an example in which the first demodulator 212 is a rectifier circuit provided with an inductor L8, diodes D1 and D2, and a capacitor C10, for example, but the configuration of the first demodulator 212 is not limited to the configuration illustrated in FIG. 7.

The second demodulator 214 demodulates the signal transmitted from the first demodulator 212 (i.e., a transmit signal according to the embodiments), and transmits a signal indicating processing commands to the processor 208. FIG. 7 herein illustrates an example in which the second demodulator 214 is a receive preamp used for infrared communication and provided with an amp 214A, a bandpass filter 214B, a detector circuit 214C, and a waveform shaper circuit 214D, for example. By utilizing a receive preamp used for infrared communication, with an electronic apparatus according to the embodiments it is possible to reduce the costs related to realizing a process in accordance with a communication method according to the embodiments more than in the case of using PLC.

However, the second demodulator 214 is not limited to a configuration that includes a receive preamp used for infrared communication. For example, the second demodulator 214 may also be realized with an arbitrarily configured circuit able to demodulate a transmit signal according to the embodiments transmitted from the first demodulator 212.

By providing the first demodulator 212 and the second demodulator 214, for example, the receiver 206 receives, via a power line, a carrier signal according to the embodiments transmitted from a communication apparatus according to the embodiments, and transmits a signal indicating processing commands to the processor 208.

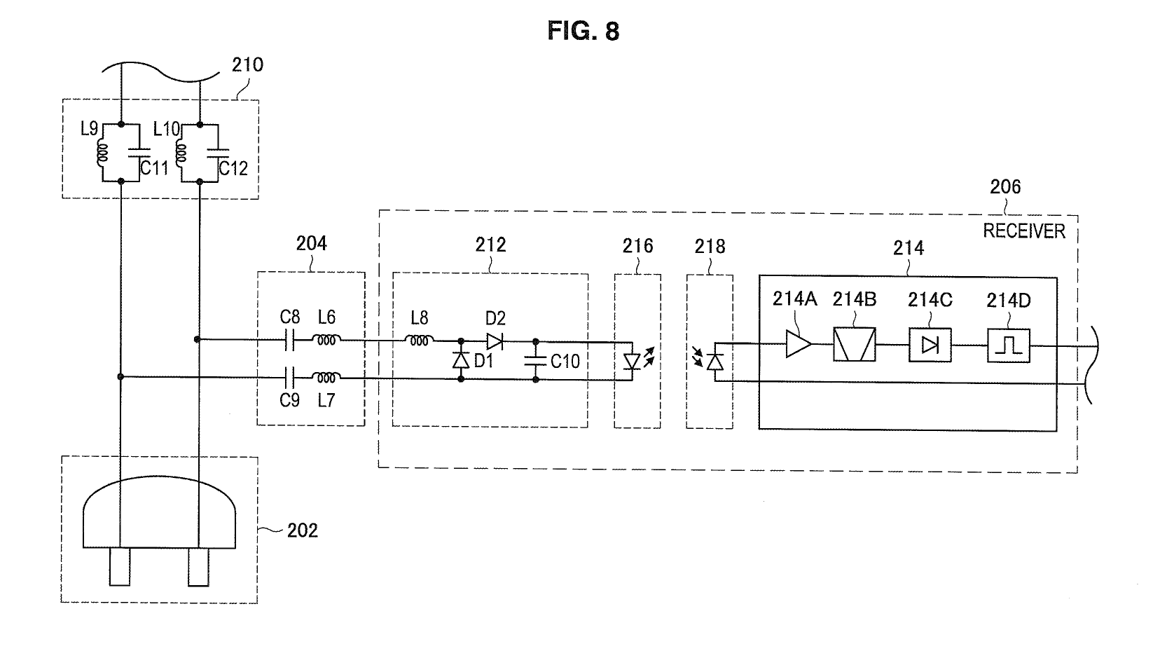

However, the configuration of the receiver 206 according to the first embodiment is not limited to the configuration illustrated in FIG. 7. FIG. 8 illustrates another exemplary configuration of a receiver 206 provided in an electronic apparatus 200A according to the first embodiment. Herein, FIG. 8 illustrates an exemplary configuration of the receiver 206 provided in the electronic apparatus 200A according to the first embodiment for the case in which a communication apparatus according to the embodiments generates a transmit signal according to the embodiments in the form of a signal that has been modulated similarly to a signal generated during infrared communication. Also, the port 202, the first filter 204, and the second filter 210 illustrated in FIG. 7 are additionally illustrated in FIG. 8.

As illustrated in FIG. 8, the receiver 206 according to another example is provided with an optical emitter 216 and an optical receiver 218 in addition to the configuration of the receiver 206 illustrated in FIG. 7. The optical emitter 216 may be an infrared light-emitting diode (LED), for example. Meanwhile, the optical receiver 218 may be an infrared photosensitive element, for example.

As illustrated in FIG. 8, a signal from the first demodulator 212 is transmitted to the optical emitter 216. At this point, in the case where a communication apparatus according to the embodiments generates a transmit signal according to the embodiments in the form of a signal that has been modulated similarly to a signal generated during infrared communication, the signal transmitted from the first demodulator 212 corresponds to the signal generated during infrared communication. Thus, in the case where a communication apparatus according to the embodiments generates a transmit signal according to the embodiments in the form of a signal that has been modulated similarly to a signal generated during infrared communication, the signal transmitted from the first demodulator 212 (i.e., a transmit signal according to the embodiments) is correctly transmitted between the optical emitter 216 and the optical receiver 218 by infrared communication.

Also, as illustrated in FIG. 8, the signal received by the optical receiver 218, or in other words the signal transmitted from the first demodulator 212 (i.e., a transmit signal according to the embodiments), is transmitted to the second demodulator 214. Thus, even with the configuration illustrated in FIG. 8, the receiver 206 according to another example is able to receive, via a power line, a carrier signal according to the embodiments transmitted from a communication apparatus according to the embodiments, and transmit a signal indicating processing commands to the processor 208, similarly to the receiver 206 illustrated in FIG. 7.

The receiver 206 may take the configuration illustrated in FIG. 7 or 8, for example. However, the configuration of the receiver 206 according to the first embodiment is not limited to the configurations illustrated in FIGS. 7 and 8. For example, it is also possible for the receiver 206 according to the first embodiment to take a configuration that does not include the second demodulator 214. In the case of taking a configuration that does not include the second demodulator 214, the receiver 206 according to the first embodiment is able to demodulate a carrier signal and transmit a transmit signal to the processor 208. Thus, the receiver 206 is still able to fulfill the leading role of conducting the above receiving process in accordance with a communication method according to the embodiments, even in the case of taking a configuration that does not include the second demodulator 214.

Referring again to FIG. 7, an exemplary configuration of the second filter 210 provided in the electronic apparatus 200A according to the first embodiment will now be described. The second filter 210 may include a band-stop filter having a capacitor C11 and an inductor L9 connected in parallel, and a band-stop filter having a capacitor C12 and an inductor L10 connected in parallel, for example. The capacitance values of the capacitors C11 and C12 and the inductance values of the inductors L9 and L10 may be set according to the frequency of the carrier signal, for example.

With the configuration illustrated in FIG. 7, for example, the second filter 210 fulfills the role of filtering signals which may be transmitted from the port 202 side of the second filter 210. However, the configuration of the second filter 210 according to the embodiments is not limited to the configuration illustrated in FIG. 7. For example, the second filter 210 may also be an arbitrarily configured filter able to block high-frequency signals without blocking signals at the power frequency (such as a low-pass filter, for example).

With the configuration illustrated in FIGS. 5, 7, and 8, for example, the electronic apparatus 200A according to the first embodiment is able to conduct the above receiving process and the above executing process in accordance with a communication method for an electronic apparatus according to the embodiments. Consequently, with the configuration illustrated in FIGS. 5, 7, and 8, for example, the electronic apparatus 200A according to the first embodiment is able to conduct a process based on processing commands transmitted via a power line.

### [2] Second Embodiment

Next, an exemplary configuration of a communication apparatus able to conduct above processes from (1) (signal generating process) to (5) (power controlling process) in accordance with a communication method for a communication apparatus according to the embodiments will now be described as a communication apparatus according to the second embodiment. Also, an exemplary configuration of an electronic apparatus able to conduct a process in accordance with power line communication according to the embodiments in addition to the above receiving process and the above executing process in accordance with a communication method for an electronic apparatus according to the embodiments will be described as an electronic apparatus according to the second embodiment.

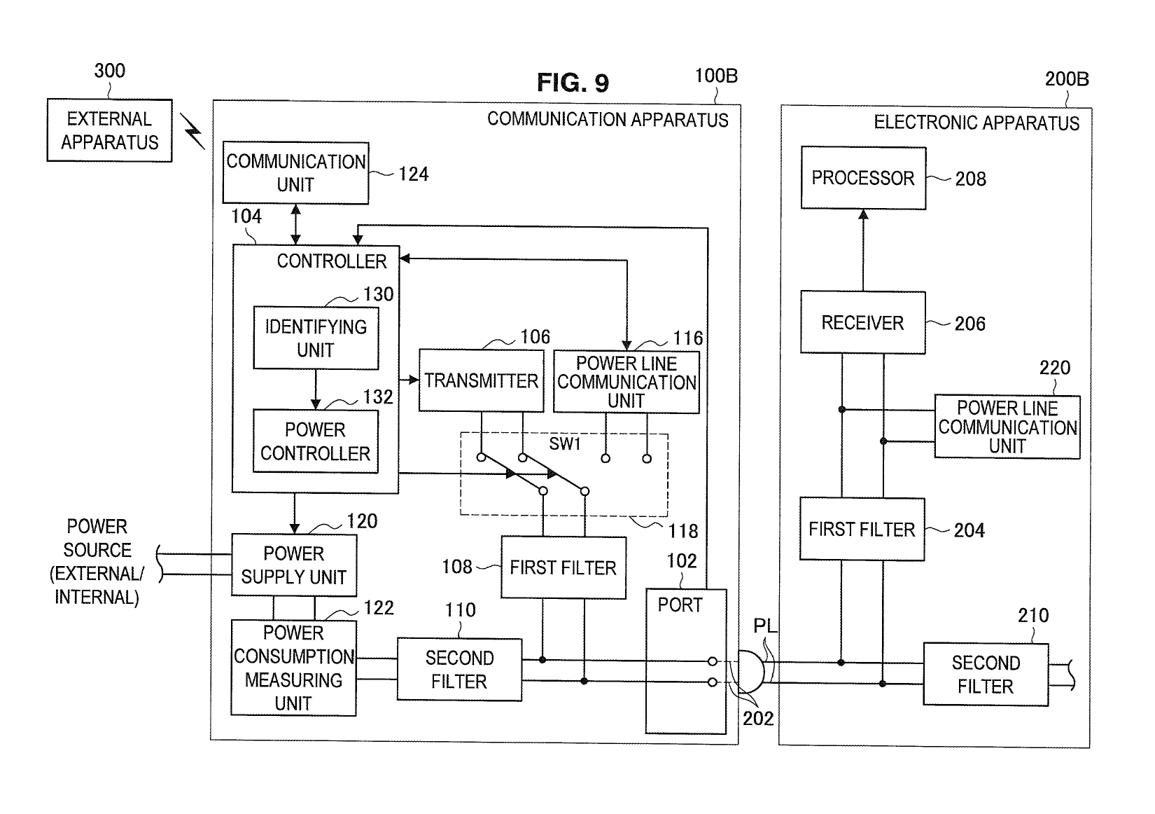

FIG. 9 illustrates exemplary configurations of a communication apparatus 100B according to the second embodiment and an electronic apparatus 200B according to the second embodiment. Herein, an external apparatus 300 able to communicate with the communication apparatus 100B is additionally illustrated in FIG. 9.

### (2-1) Exemplary Configuration of Communication Apparatus 100B According to the Second Embodiment

The communication apparatus 100B is equipped with a port 102, a controller 104, a transmitter 106, a first filter 108 (communication filter), a second filter 110, a power line communication unit 116, a switching unit 118, a power supply unit 120, a power consumption measuring unit 122, and a communication unit 124, for example.

The communication apparatus 100B may also be equipped with ROM (not illustrated), RAM (not illustrated), a storage unit (not illustrated), a display unit (not illustrated), and an operable unit (not illustrated) that is operable by the user, for example. Respective components in the communication apparatus 100B may be connected to each other by a bus that acts as a data transmission line, for example.

The port 102 and the transmitter 106 have similar functionality and configurations as the port 102 and the transmitter 106 according to the first embodiment illustrated in FIG. 5.

The controller 104 may be realized with an MPU or various processor circuits, for example, and fulfills the role of controlling the communication apparatus 100B overall. In addition, the controller 104 may be equipped with an identifying unit 130 and a power controller 132, for example, and fulfill the leading role of conducting the above process (4) (identifying process) and the process (5) (power controlling process) in accordance with a communication method according to the embodiments.

The controller 104 may also control communication in the power line communication unit 116, for example. In other words, the controller 104 fulfills a partial role of conducting the above process (3) (identification information acquiring process) in accordance with a communication method according to the embodiments.

Furthermore, the controller 104 may also selectively connect a power line to the transmitter 106 or the power line communication unit 116 by issuing a switching signal to the switching unit 118, for example.

The identifying unit 130 fulfills the leading role of conducting the above process (4) (identifying process), and identifies connected external apparatus on the basis of identification information acquired by power line communication in the power line communication unit 116.

The power controller 132 fulfills the leading role of conducting the above process (5) (power controlling process), and selectively transmits power to connected external apparatus identified by the identifying unit 130. More specifically, the power controller 132 may selectively transmit power to connected external apparatus by issuing to the power supply unit 120 a control signal that controls the selective supply of power over the power line PL in the power supply unit 120 and thus control the behavior of the power supply unit 120, for example.

By providing the identifying unit 130 and the power controller 132, for example, the controller 104 leads in conducting the above process (4) (identifying process) and the process (5) (power controlling process) in accordance with a communication method according to the embodiments.

The first filter 108 has a configuration that is basically similar to that of the first filter 108 according to the first embodiment illustrated in FIG. 5, but differs therefrom with the additional inclusion of functionality for not blocking signals of high frequency related to power line communication according to the embodiments. Likewise, the second filter 110 has a configuration that is basically similar to that of the second filter 110 according to the first embodiment illustrated in FIG. 5, but differs therefrom with the additional inclusion of functionality for blocking signals of high frequency related to power line communication according to the embodiments.

The power line communication unit 116 fulfills the role of conducting power line communication according to the embodiments with connected external apparatus.

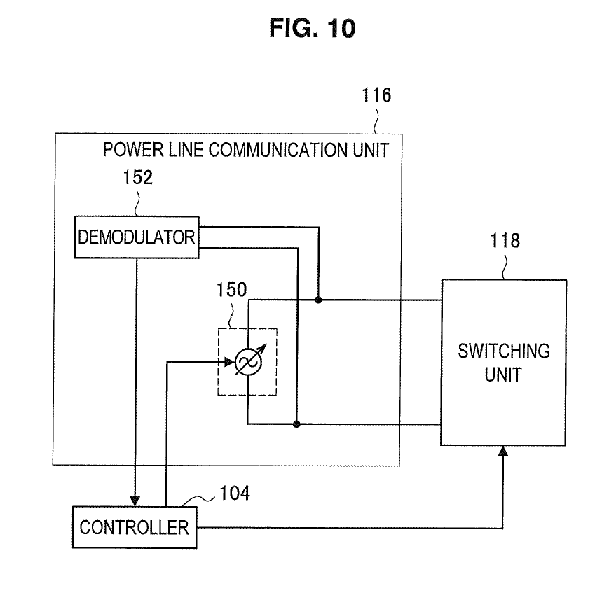

FIG. 10 illustrates an exemplary configuration of a power line communication unit 116 provided in the communication apparatus 100B according to the second embodiment. Herein, the controller 104 and the switching unit 118 are additionally illustrated in FIG. 10.

The power line communication unit 116 is equipped with a high-frequency signal generator 150 and a demodulator 152, for example, and fulfills a role like that of an NFC reader/writer (or interrogator), for example. The power line communication unit 116 may be additionally equipped with an encryption circuit (not illustrated) or an anti-collision circuit, for example.

The high-frequency signal generator 150 receives a command for generating a high-frequency signal issued from the controller 104, for example, and generates a high-frequency signal according to the generate command. In addition, the high-frequency signal generator 150 receives a command for stopping the transmission of a high-frequency signal which is issued from the controller 104, for example, and stops generating a high-frequency signal. Although an AC power source is illustrated as the high-frequency signal generator 150 herein, the high-frequency signal generator 150 according to the embodiments is not limited to the above. For example, the high-frequency signal generator 150 according to the embodiments may be equipped with a modulator circuit (not illustrated) that conducts ASK modulation, and an amplifier circuit (not illustrated) that amplifies the output from the modulator circuit.

Potential examples of a high-frequency signal generated by the high-frequency signal generator 150 include a high-frequency signal containing an identification information transmit request that requests connected external apparatus to transmit identification information, or a high-frequency signal containing various processing commands for, or data to be processed by, connected external apparatus, for example. However, a high-frequency signal generated by the high-frequency signal generator 150 is not limited to the above. For example, a high-frequency signal according to the embodiments may also be a signal that fulfills the role of supplying power to the power line communication unit 220 of the electronic apparatus 200B discussed later (an unmodulated signal, for example).

The demodulator 152 demodulates a response signal transmitted from connected external apparatus by performing envelope detection of amplitude changes in the voltage between the high-frequency signal generator 150 and the switching unit 118, and binarizing the detected signal, for example. The demodulator 152 then transmits the demodulated response signal (such as a response signal indicating identification information or a response signal indicating a response based on processing performed according to a high-frequency signal, for example) to the controller 104. However, the technique of demodulating a response signal in the demodulator 152 is not limited to the above. For example, the demodulator 152 may also demodulate a response signal using phase changes in the voltage between the high-frequency signal generator 150 and the switching unit 118.

With the configuration illustrated in FIG. 10, for example, the power line communication unit 116 according to the embodiments fulfills a role as an NFC reader/writer, for example, and is able to fulfill the role of conducting power line communication according to the embodiments with connected external apparatus via a power line.

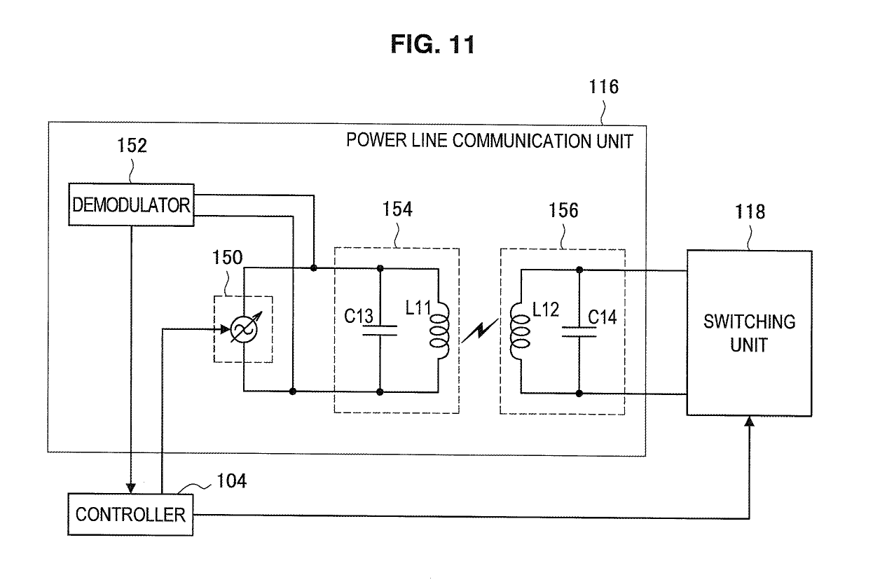

However, the configuration of the power line communication unit 116 according to the embodiments is not limited to the configuration illustrated in FIG. 10. FIG. 11 illustrates another example of a power line communication unit 116 provided in the communication apparatus 100B according to the second embodiment. Herein, the controller 104 and the switching unit 118 are additionally illustrated in FIG. 11, similarly to FIG. 10.

The power line communication unit 116 according to another example is equipped with a high-frequency signal generator 150, a demodulator 152, a first high-frequency transceiver 154, and a second high-frequency transceiver 156. The power line communication unit 116 according to another example may be additionally equipped with an encryption circuit (not illustrated) or an anti-collision circuit, for example.

Similarly to the high-frequency signal generator 150 illustrated in FIG. 10, the high-frequency signal generator 150 generates a high-frequency signal according to a generate command, and stops generating a high-frequency signal according to a stop command.

The demodulator 152 demodulates a response signal transmitted from connected external apparatus by performing envelope detection of amplitude changes in the voltage at the antenna terminal of the first high-frequency transceiver 154, and binarizing the detected signal. However, the technique of demodulating a response signal in the demodulator 152 is not limited to the above. For example, the demodulator 152 may also demodulate a response signal using phase changes in the voltage at the antenna terminal of the first high-frequency transceiver 154.

The first high-frequency transceiver 154 is equipped with a coil L11 having a given inductance (i.e., an inductor, and discussed similarly hereinafter) and a capacitor C13 having a given capacitance, for example, and constitutes a resonant circuit. Herein, the resonant frequency of the first high-frequency transceiver 154 may be the frequency of the high-frequency signal, such as 13.56 MHz, for example. With the above configuration, the first high-frequency transceiver 154 is able to transmit a high-frequency signal generated by the high-frequency signal generator 150, or alternatively, receive a response signal transmitted from connected external apparatus and then transmitted from the second high-frequency transceiver 156. In other words, the first high-frequency transceiver 154 fulfills a role as a first communication antenna within the power line communication unit 116.

The second high-frequency transceiver 156 is equipped with a coil L12 having a given inductance and a capacitor C14 having a given capacitance, for example, and constitutes a resonant circuit. Herein, the resonant frequency of the second high-frequency transceiver 156 may be the frequency of the high-frequency signal, such as 13.56 MHz, for example. With the above configuration, the second high-frequency transceiver 156 is able to receive a high-frequency signal transmitted from the first high-frequency transceiver 154, or alternatively, transmit a response signal transmitted from connected external apparatus. In other words, the second high-frequency transceiver 156 fulfills a role as a second communication antenna within the power line communication unit 116.

Even with the configuration illustrated in FIG. 11, the power line communication unit 116 according to the embodiments is still able to fulfill a role as an NFC reader/writer, for example, and is able to fulfill the role of conducting power line communication according to the embodiments with connected external apparatus via a power line, similarly to the configuration illustrated in FIG. 10.

Returning once again to FIG. 9, an exemplary configuration of a communication apparatus 100B according to the second embodiment will now be described. The switching unit 118 selectively connects the transmitter 106 or the power line communication unit 116 to the power line PL (more strictly, to the power line PL via the first filter 108). More specifically, the switching unit 118 is equipped with a switch SW1 that selectively changes the destination on the basis of a switching signal issued from the controller 104, and selectively switches the destination on the basis of the switching signal, for example.

The power supply unit 120 selectively connects a power source (such as an internal power source or an external power source, for example) to the power line PL and selectively supplies power along the power line PL on the basis of a control signal issued from the controller 104 (more strictly, the power controller 132), for example.

The power supply unit 120 herein may be a switch that switches on/off on the basis of a control signal issued from the controller 104, for example. The above switch may be realized with a p-channel metal-oxide-semiconductor field-effect transistor (MOSFET) or an n-channel MOSFET, but the switch configuration is not limited to the above.

The power consumption measuring unit 122 measures power consumption expended by connected external apparatus such as the electronic apparatus 200B connected to the port 102. The power consumption measuring unit 122 then issues information on the measured power consumption to the controller 104. The power consumption measuring unit 122 herein may be a wattmeter, for example. By providing the power consumption measuring unit 122, the communication apparatus 100B according to the second embodiment is able to conduct a process in accordance with a communication method according to the embodiments on the basis of conditions related to power consumption.

The communication unit 124 provided in the communication apparatus 100B communicates with a user terminal such as a mobile phone, a server, or other external apparatus 300 in a wired or wireless manner via a network (or directly). In addition, communication in the communication unit 124 is controlled by the controller 104, for example.

As an example, in the case where the external apparatus 300 is an apparatus that transmits a transmit request requesting the transmission of processing commands (hereinafter designated a “control apparatus” in some cases), the communication apparatus 100B conducts the above process (1) (signal generating process) and the above process (2) (transmitting process) in accordance with a communication method according to the embodiments on the basis of a transmit request transmitted from the control apparatus and received by the communication unit 124. In other words, the communication apparatus 100B is able to conduct a process in accordance with a communication method according to the embodiments as a process in a communication system that includes a control apparatus and the communication apparatus 100B according to the embodiments.

The control apparatus according to the embodiments may transmit a transmit request on the basis of user operations, for example. The control apparatus according to the embodiments may also make a determination regarding a preset condition such as a temperature, humidity, or illumination condition, and transmit a transmit request on the basis of the determination result for the condition, for example. The control apparatus according to the embodiments may also acquire a detection value for making a determination regarding a preset condition with a detecting device corresponding to the preset condition and provided in the control apparatus according to the embodiments, or from an external apparatus such as a communication apparatus according to the embodiments.

Also, by providing the communication unit 124, the communication apparatus 100B is able to conduct a process similar to the case of providing a communication unit in the communication apparatus according to the first embodiment discussed earlier.

The communication unit 124 herein may be a communication antenna and RF circuit (wireless communication), an IEEE 802.15.1 port and transceiver circuit (wireless communication), an IEEE 802.11b port and transceiver circuit (wireless communication), or a LAN port and transceiver circuit (wired communication), for example.

With the configuration illustrated in FIG. 9, for example, the communication apparatus 100B according to the second embodiment is able to conduct the above processes from (1) (signal generating process) to (5) (power controlling process) in accordance with a communication method for a communication apparatus according to the embodiments. Consequently, with the configuration illustrated in FIG. 9, for example, the communication apparatus 100B according to the second embodiment is able to control the supply of power to connected external apparatus.

In addition, the communication apparatus 100B according to the second embodiment has a configuration similar to that of the communication apparatus 100A according to the first embodiment basically illustrated in FIG. 5. Consequently, the communication apparatus 100B according to the second embodiment is able to cause an electronic apparatus to conduct a process based on processing commands transmitted via a power line, similarly to the communication apparatus 100A according to the first embodiment.

However, the configuration of the communication apparatus 100B according to the second embodiment is not limited to the configuration illustrated in FIG. 9. For example, a communication apparatus according to the second embodiment may also be equipped with multiple ports. In the case of a configuration equipped with multiple ports, a communication apparatus according to the second embodiment may transmit a carrier signal according to the embodiments to connected external apparatus respectively connected to each port, for example. Additionally, in the case of a configuration equipped with multiple ports, a communication apparatus according to the second embodiment is able to control the supply of power to each connected external apparatus respectively connected to each port.

In addition, similarly to the communication apparatus 100A according to the first embodiment, a communication apparatus according to the second embodiment may also be equipped with various sensors that output a detection value regarding a preset condition, such as temperature sensors, humidity sensors, and illumination sensors, for example (these being examples of a detecting device corresponding to a preset condition). By providing a detecting device corresponding to a preset condition, a communication apparatus according to the second embodiment is able to conduct a process in accordance with a communication method according to the embodiments on the basis of a detection value from the detecting device and the preset condition.

Furthermore, the communication apparatus according to the second embodiment may also not be equipped with the power supply unit 120 in cases such as when an apparatus (or circuit) including functionality equivalent to the power supply unit 120 is present as an external apparatus (or circuit) to the communication apparatus according to the embodiments, for example. In the above case, even if the power supply unit 120 is not provided, the communication apparatus according to the second embodiment is still able to selectively transmit power connected external apparatus by controlling the apparatus (or circuit) including functionality equivalent to the power supply unit 120 in a manner similar to controlling the power supply unit 120, for example.

It is also possible for the communication apparatus according to the second embodiment to take a configuration that does not include the power consumption measuring unit 122 or the communication unit 124, for example.

### (2-2) Exemplary Configuration of Electronic Apparatus 200B According to the Second Embodiment

The electronic apparatus 200B is equipped with a port 202, a first filter 204 (communication filter), a receiver 206, a processor 208, a second filter 210, and a power line communication unit 220, for example.

The electronic apparatus 200B may also be equipped with, for example, a battery (not illustrated) and various devices for realizing functionality included in the electronic apparatus 200B, which may be provided downstream to the second filter 210 (i.e., on the side of the second filter 210 opposite the communication apparatus 100B as illustrated in FIG. 9), similarly to the electronic apparatus 200A according to the first embodiment illustrated in FIG. 5, for example.

The port 202, the receiver 206, and the processor 208 have similar functionality and configurations as the port 202, the receiver 206, and the processor 208 according to the first embodiment illustrated in FIG. 5.

Also, the first filter 204 has a configuration that is basically similar to that of the first filter 204 according to the first embodiment illustrated in FIG. 5, but differs therefrom with the additional inclusion of functionality for not blocking signals of high frequency related to power line communication according to the embodiments. Likewise, the second filter 210 has a configuration that is basically similar to that of the second filter 210 according to the first embodiment illustrated in FIG. 5, but differs therefrom with the additional inclusion of functionality for blocking signals of high frequency related to power line communication according to the embodiments.

The power line communication unit 220 fulfills the role of conducting power line communication according to the embodiments with an external apparatus via a power line by conducting load modulation on the basis of a signal transmitted from an external apparatus via a power line.

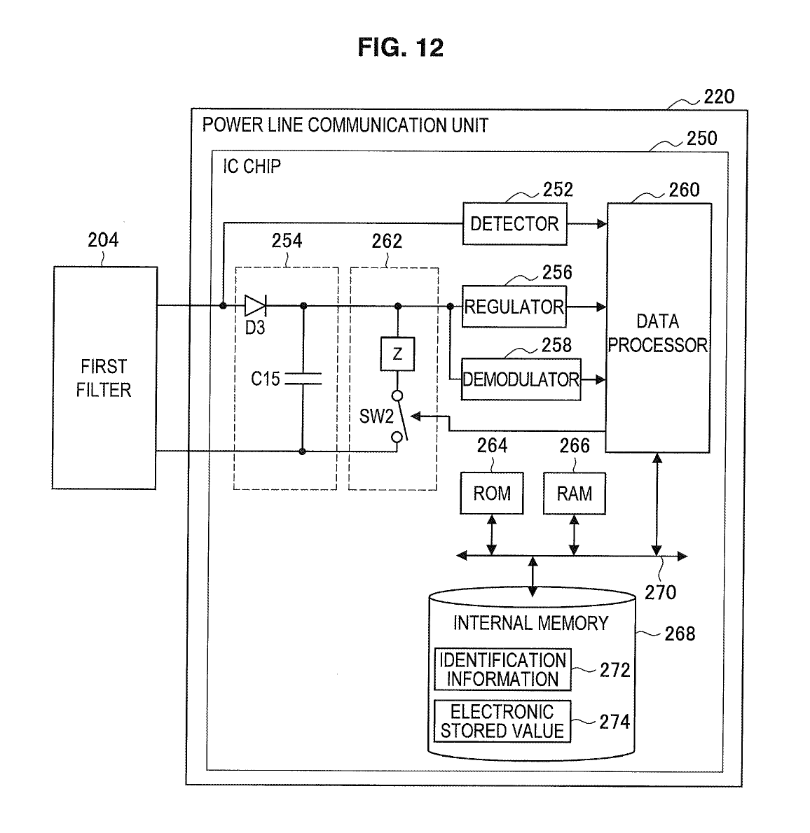

FIG. 12 illustrates an exemplary configuration of a power line communication unit 220 provided in the electronic apparatus 200B according to the second embodiment. Herein, the first filter 204 is additionally illustrated in FIG. 12. Also, FIG. 12 illustrates a configuration in which the power line communication unit 220 is equipped with an IC chip 250 that demodulates and processes a received high-frequency signal, and causes a response signal to be transmitted by load modulation. However, the respective components that constitute the IC chip 250 illustrated in FIG. 12 may also be provided in the power line communication unit 220 according to the embodiments in a manner other than an IC chip.

The IC chip 250 is equipped with a detector 252, a detector 254, a regulator 256, a demodulator 258, a data processor 260, and a load modulator 262. Although not illustrated in FIG. 12, the IC chip 250 may be additionally equipped with a protection circuit (not illustrated) for preventing the application of excessive voltage or excessive current to the data processor 260, for example. Potential examples of a protection circuit (not illustrated) include a clamp circuit realized with a diode, for example.

The IC chip 250 is also equipped with ROM 264, RAM 266, and internal memory 268, for example. The data processor 260, the ROM 264, the RAM 266, and the internal memory 268 are connected by a bus 270 that acts as a data transmission line, for example.

The detector 252 generates a square wave detection signal, for example, on the basis of a high-frequency signal transmitted from a connected external apparatus such as the communication apparatus 100B and transmitted from the first filter 204, and issues the detection signal to the data processor 260. The data processor 260 uses the issued detection signal as a processing block in a data process, for example. Herein, since the above detection signal is based on a high-frequency signal transmitted from a connected external apparatus, the above detection signal is synchronized with the frequency of the high-frequency signal transmitted from the connected external apparatus. Consequently, by providing the detector 252, the IC chip 250 is able to conduct processing between itself and a connected external apparatus in synchronization with the connected external apparatus.

The detector 254 rectifies a high-frequency signal transmitted from the first filter 204. The 254 may be realized with a diode D3 and a capacitor C15, for example.

The regulator 256 smoothes the high-frequency signal, makes the voltage constant, and outputs a driving voltage to the data processor 260. Herein, the regulator 256 may use the DC component of the high-frequency signal as driving voltage, for example.

The demodulator 258 demodulates the high-frequency signal and outputs data corresponding to the high-frequency signal (such as a data signal binarized into a high level and a low level, for example). Herein, the demodulator 258 may output the AC component of the high-frequency signal as data, for example.

The data processor 260 processes the data demodulated by the demodulator 258, driving itself with the driving voltage output from the regulator 256 as a power source, for example. The data processor 260 herein may be realized with an MPU or various processor circuits, for example.

In addition, the data processor 260 selectively generates, according to the processing results, a control signal that controls load modulation related to a response to a connected external apparatus. The data processor 260 then selectively outputs the control signal to the load modulator 262.

The data processor 260 may also retrieve and update data stored in the internal memory 268 on the basis of commands included in data demodulated by the demodulator 258, for example.

The load modulator 262 is provided with a load Z and a switch SW2, for example, and conducts load modulation by selectively connecting (enabling) the load Z according to a control signal issued from the data processor 260. Although the load Z herein may be realized with a resistor having a given resistance value, for example, the load Z is not limited to the above. Also, although the switch SW2 may be realized with a p-channel MOSFET or an n-channel MOSFET, for example, the switch SW2 is not limited to the above.

The ROM 264 stores programs used by the data processor 260 and control data such as computational parameters. The RAM 266 temporarily stores information such as programs executed by the data processor 260, computational results, and execution states.

The internal memory 268 provided in the IC chip 250 is tamper-resistant, for example, and is subjected to data retrieval, (new) data writing, and data update operations by the data processor 260, for example. The internal memory 268 may store various data such as identification information, digital stored values (currency or data having a value based on currency), and applications, for example. Note that although FIG. 12 illustrates an example in which the internal memory 268 stores identification information 272 and an electronic stored value 274, data stored by the internal memory 268 is not limited to the above.

With a configuration like the above illustrated in FIG. 12, for example, the IC chip 250 is able to demodulate and process an input high-frequency signal, and transmit a response signal in response to the high-frequency signal by load modulation.

In addition, the IC chip 250 is connected to the first filter 204 as illustrated in FIG. 12, while the first filter 204 is connected to the power line PL as illustrated in FIG. 9. Thus, a response signal transmitted from the IC chip 250 is impressed onto a power line via the first filter 204.

With the configuration illustrated in FIG. 12, for example, the IC chip 250 processes a received high-frequency signal, and causes a response signal to be impressed onto a power line and transmitted by load modulation. However, the configuration of the IC chip 250 according to the embodiments obviously is not limited to the configuration illustrated in FIG. 12.

With the configuration illustrated in FIG. 12, for example, the power line communication unit 220 is able to drive itself with power obtained from a received high-frequency signal, conduct a process indicated by the received high-frequency signal, and transmit a response signal according to the process by load modulation.

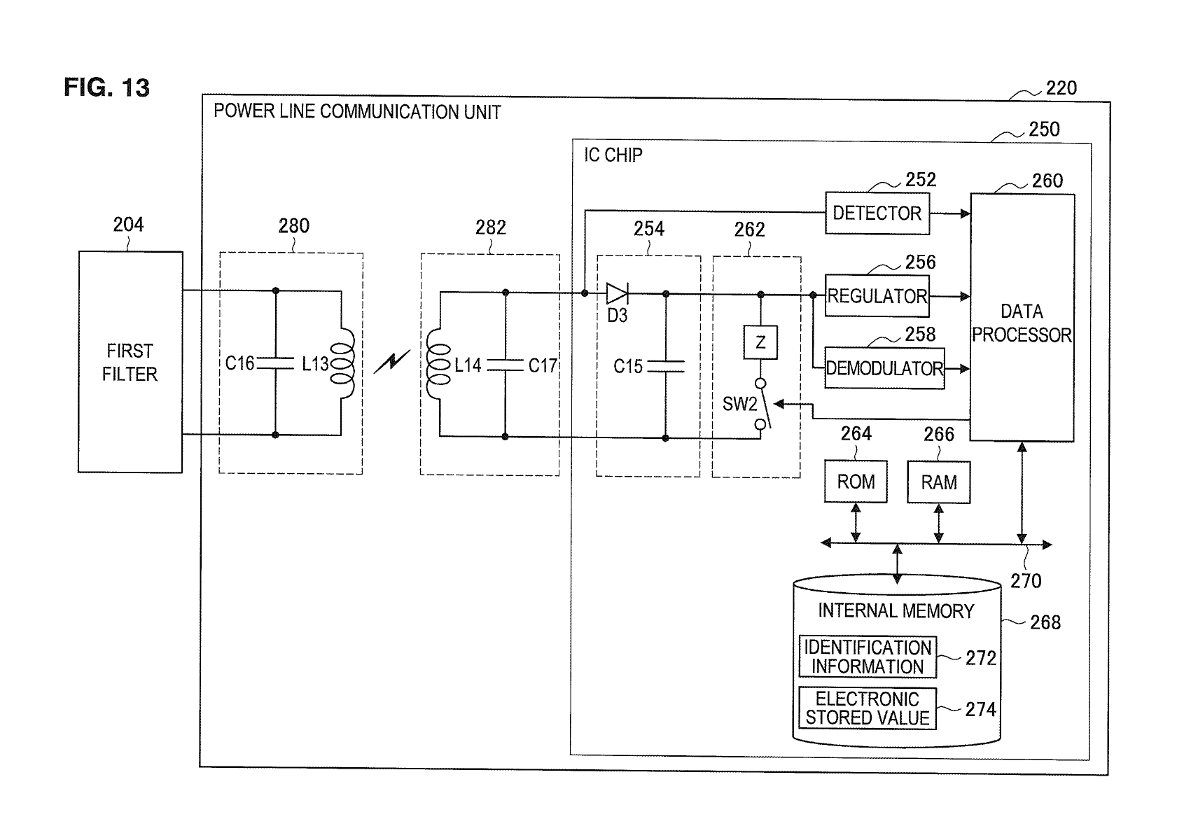

However, the configuration of the power line communication unit 220 according to the embodiments is not limited to the configuration illustrated in FIG. 12. FIG. 13 illustrates another exemplary configuration of a power line communication unit 220 provided in the electronic apparatus 200B according to the second embodiment. Herein, the first filter 204 is additionally illustrated in FIG. 13. Note that the respective components that constitute the IC chip 250 illustrated in FIG. 13 may also be provided in the power line communication unit 220 according to the embodiments in a manner other than an IC chip.

The power line communication unit 220 according to another example is equipped with a first high-frequency transceiver 280, a second high-frequency transceiver 282, and an IC chip 250.

The first high-frequency transceiver 280 is equipped with a coil L13 having a given inductance and a capacitor C16 having a given capacitance, for example, and constitutes a resonant circuit. Herein, the resonant frequency of the first high-frequency transceiver 280 may be the frequency of the high-frequency signal, such as 13.56 MHz, for example. With the above configuration, the first high-frequency transceiver 280 is able to transmit a high-frequency signal transmitted from the first filter 204, or alternatively, receive a response signal transmitted from the second high-frequency transceiver 282. In other words, the first high-frequency transceiver 280 fulfills a role as a first communication antenna within the power line communication unit 220.

The second high-frequency transceiver 282 is equipped with a coil L14 having a given inductance and a capacitor C17 having a given capacitance, for example, and constitutes a resonant circuit. Herein, the resonant frequency of the second high-frequency transceiver 282 may be the frequency of the high-frequency signal, such as 13.56 MHz, for example. With the above configuration, the second high-frequency transceiver 282 is able to receive a high-frequency signal transmitted from the first high-frequency transceiver 280, or alternatively, transmit a response signal. More specifically, upon receiving a high-frequency signal, the second high-frequency transceiver 282 produces an inductive voltage due to electromagnetic induction, and outputs a receive voltage resonant with the inductive voltage at a given resonant frequency to the IC chip 250. The second high-frequency transceiver 282 also transmits a response signal by load modulation conducted by the load modulator 262 provided in the IC chip 250. In other words, the second high-frequency transceiver 282 fulfills a role as a second communication antenna within the power line communication unit 220.

The IC chip 250 conducts a process similarly to the IC chip 250 illustrated in FIG. 12 on the basis of a receive voltage transmitted from the second high-frequency transceiver 282.

Even with the configuration illustrated in FIG. 13, the power line communication unit 220 is still able to drive itself with power obtained from a received high-frequency signal, conduct a process indicated by the received high-frequency signal, and transmit a response signal according to the process by load modulation, similarly to the configuration illustrated in FIG. 12. Also, providing the power line communication unit 220 with the configuration illustrated in FIG. 13 makes it possible to repurpose NFC- and RFID-related IC chips, and thus has the advantage of easier implementation and packaging.

By providing the configuration illustrated in FIG. 12 or 13, for example, the power line communication unit 220 is able to conduct power line communication according to the embodiments with an external apparatus via a power line by conducting load modulation on the basis of a signal transmitted from an external apparatus via a power line.

With the configuration illustrated in FIG. 9, for example, the electronic apparatus 200B according to the second embodiment is able to incorporate functionality for power line communication according to the embodiments.

In addition, the electronic apparatus 200B according to the second embodiment has a configuration similar to that of the electronic apparatus 200A according to the first embodiment basically illustrated in FIG. 5. Consequently, the electronic apparatus 200B according to the second embodiment is able to conduct a process based on processing commands transmitted via a power line, similarly to the electronic apparatus 200A according to the first embodiment.

### (Relay Node According To The Embodiments)

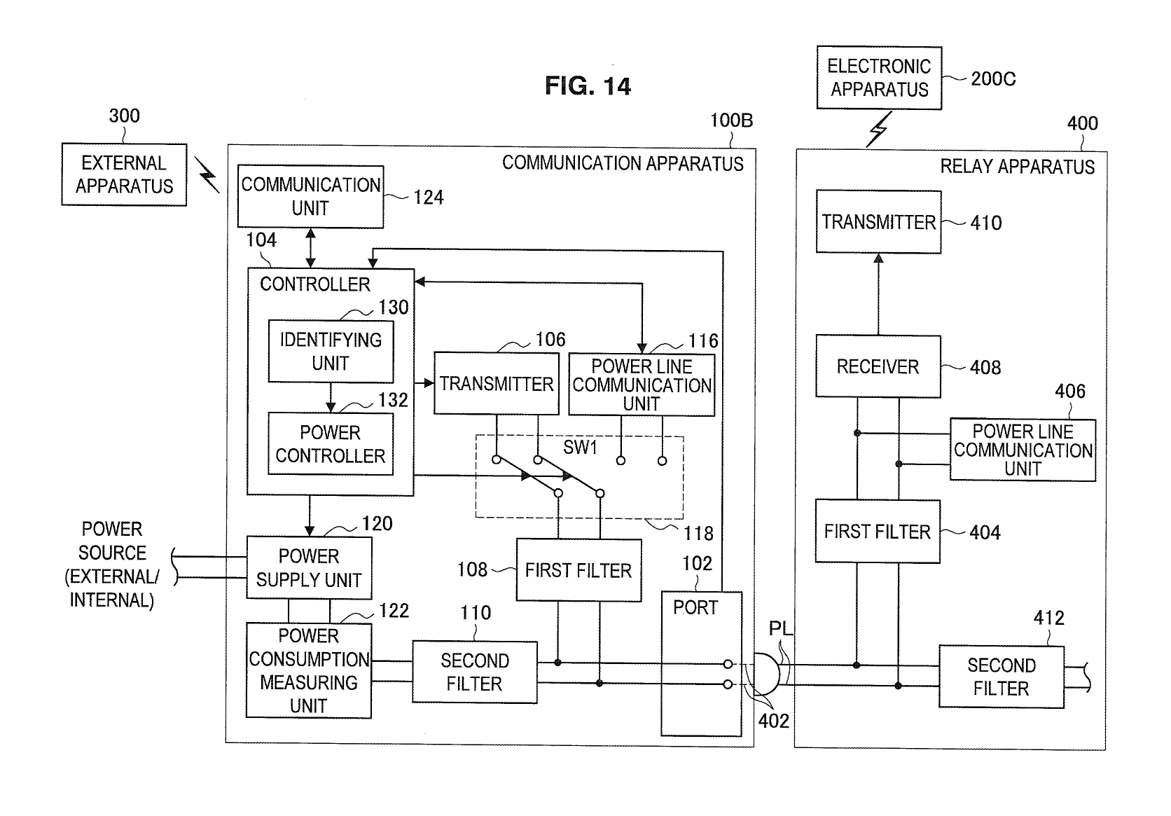

Next, an exemplary configuration of a relay node according to the embodiments which is able to conduct a process in accordance with a communication method according to the embodiments as discussed above will be described. FIG. 14 illustrates an exemplary configuration of a relay node 400 according to the embodiments. Similarly to FIG. 9, the communication apparatus 100B according to the second embodiment and an external apparatus 300 able to communicate with the communication apparatus 100B are additionally illustrated in FIG. 14.

Furthermore, additionally illustrated in FIG. 14 is an electronic apparatus 200C able to receive a transmit signal according to the embodiments that has been retransmitted by the relay node 400, and conduct a process based on processing commands contained in the transmit signal according to the embodiments. For example, in the case where the transmit signal according to the embodiments is a signal that has been modulated similarly to a signal generated during infrared communication, the electronic apparatus 200C includes functionality for receiving and processing signals related to infrared communication. In other words, in the case where the electronic apparatus 200C includes functionality for receiving and processing signals related to infrared communication, for example, the electronic apparatus 200C receives and processes a transmit signal according to the embodiments that has been retransmitted by the relay node 400, similarly to a signal transmitted from a remote control that transmits a signal containing processing commands by infrared communication, for example.

The relay node 400 is equipped with a port 402, a first filter 404 (communication filter), a power line communication unit 406, a receiver 408, a transmitter 410, and a second filter 412, for example.

The relay node 400 may also be equipped with, for example, a battery (not illustrated) and various devices for realizing functionality included in the relay node 400, which may be provided downstream to the second filter 412 (i.e., on the side of the second filter 412 opposite the communication apparatus 100B as illustrated in FIG. 14).

The port 402 includes a terminal connected to the power line PL (corresponding to an external power line from the perspective of the communication apparatus 100B), similarly to the port 202 provided in the electronic apparatus 200A illustrated in FIG. 5, for example. The communication apparatus 100B and the relay node 400 are thus connected by electrically connecting the terminal included in the port 102 provided in the communication apparatus 100B to the terminal included in the port 402, for example. Note that the port 402 may also be provided with a connection support member that helps to maintain a connected state with an external apparatus connected thereto, similarly to the port 202 provided in the communication apparatus 200A illustrated in FIG. 5.

The first filter 404 has a similar functionality and configuration as the first filter 204 provided in the electronic apparatus 200B illustrated in FIG. 9, for example, is connected between a power line (strictly, the power line PL inside the relay node 400) and the receiver 408, and fulfills the role of filtering signals transmitted along the power line. More specifically, the first filter 404 includes functionality for at least blocking signals at the power frequency while not blocking signals at the carrier frequency and signals at high frequencies from among the signals delivered along the power line.

The power line communication unit 406 includes a functionality and configuration similar to the power line communication unit 220 provided in the electronic apparatus 200B illustrated in FIG. 9, for example, and fulfills the role of conducting power line communication according to the embodiments with an external apparatus via a power line by conducting load modulation on the basis of a signal transmitted from an external apparatus via a power line.

The receiver 408 fulfills the leading role of conducting the above receiving process in accordance with a communication method according to the embodiments, and receives, via a power line, a carrier signal according to the embodiments transmitted from a communication apparatus according to the embodiments. More specifically, the receiver 408 may receive a carrier signal via a power line, and demodulate the received carrier signal according to a procedure that is the reverse of the modulating procedure in the communication apparatus according to the embodiments discussed earlier, for example. The receiver 408 then transmits a transmit signal to the transmitter 410.

The receiver 408 herein may be realized with a rectifier circuit, similarly to the first demodulator 212 illustrated in FIG. 7, for example. However, the configuration of the receiver 408 is not limited to a configuration similar to that of the first demodulator 212 illustrated in FIG. 7.

The transmitter 410 fulfills the leading role of conducting the above relaying process in accordance with a communication method according to the embodiments, and transmits a signal transmitted from the receiver 408 (i.e., a transmit signal corresponding to a received carrier signal) to an external apparatus such as the electronic apparatus 200C in a wired or wireless manner.

For example, in the case where the transmit signal according to the embodiments is a signal that has been modulated similarly to a signal generated during infrared communication, the transmitter 410 may be realized with an infrared LED, similarly to the optical emitter 216 illustrated in FIG. 8, for example. However, the transmitter 410 is not limited to being an infrared LED. It is also possible for the transmitter 410 to take various configurations enabling communication with external apparatus, such as a communication antenna and RF circuit (wireless communication), an IEEE 802.15.1 port and transceiver circuit (wireless communication), an IEEE 802.11b port and transceiver circuit (wireless communication), or a LAN port and transceiver circuit (wired communication), for example.

The second filter 412 has a similar functionality and configuration as the second filter 210 provided in the electronic apparatus 200B illustrated in FIG. 9, for example, and fulfills the role of filtering signals which may be transmitted from external apparatus such as the communication apparatus 100B via a power line. More specifically, the second filter 412 at least includes functionality for blocking signals at the carrier frequency according to the embodiments and signals at high frequencies, while not blocking signals at the frequency of the power supplied via a power line.

With the configuration illustrated in FIG. 14, for example, the relay node 400 according to the embodiments is able to conduct the above receiving process and the above relaying process in accordance with a communication method for a relay node according to the embodiments. Consequently, with the configuration illustrated in FIG. 14, for example, the relay node 400 according to the embodiments is able to cause an electronic apparatus (external apparatus) to conduct a process based on processing commands transmitted via a power line.

Also, with the configuration illustrated in FIG. 14, for example, the relay node 400 according to the embodiments is able to incorporate functionality for power line communication according to the embodiments.

However, the configuration of the relay node 400 according to the embodiments is not limited to the configuration illustrated in FIG. 14. For example, it is also possible for the relay node according to the embodiments to take a configuration that does not include the power line communication unit 406 illustrated in FIG. 14. Even with a configuration that does not include the power line communication unit 406, the relay node according to the embodiments is still able to conduct the above receiving process and the above relaying process in accordance with a communication method for a relay node according to the embodiments. Thus, even with a configuration that does not include the power line communication unit 406, the relay node according to the embodiments is still able to cause an electronic apparatus (external apparatus) to conduct a process based on processing commands transmitted via a power line.

Although the foregoing describes a communication apparatus as an example of the embodiments, the embodiments are not limited to such an example. The embodiment may also be applied to various equipment and facilities, such as power outlets installed in a building, computers such as personal computers (PCs) and servers, power taps, apparatus able to supply power to electric cars or equipment that runs on power, display apparatus, and vehicles such as electric cars, for example.

In addition, although the foregoing describes an electronic apparatus as an example of the embodiments, the embodiments are not limited to such an example. The embodiments may also be applied to various equipment, such as PCs and other computers, communication apparatus such as mobile phones and smartphones, video/audio players (or video/audio recorders), portable game consoles, display apparatus, televisions, illumination equipment, toasters, and vehicles driven by power such as electric cars, for example. The embodiments may also be applied to plugs, for example.

In addition, although the foregoing describes a relay node as an example of the embodiments, the embodiments are not limited to such an example. The embodiments may also be applied to various equipment, such as PCs and other computers, power taps, and devices (what may be called accessories) that conduct a process in accordance with a communication method for a relay node according to the embodiments, for example.

In addition, although the foregoing describes a control apparatus as an example of the embodiments, the embodiments are not limited to such an example. The embodiments may also be applied to various equipment, including computers such as PCs and servers, communication apparatus such as mobile phones and smartphones, and remote controls, for example.

The foregoing thus describes preferred embodiments of the present disclosure in detail and with reference to the attached drawings. However, the technical scope of the present disclosure is not limited to such examples. It is clear to persons ordinarily skilled in the technical field of the present disclosure that various modifications or alterations may occur insofar as they are within the scope of the technical ideas stated in the claims, and it is to be understood that such modifications or alterations obviously belong to the technical scope of the present disclosure.

Additionally, the present technology may also be configured as below.

(1) A communication apparatus including:

a port that connects a power line, along which power is transmitted at a given frequency, to an external apparatus;

a transmitter that transmits, via the power line, a carrier signal obtained by modulating a transmit signal that has been obtained by encoding a processing command for executing a given process, at a carrier frequency higher than the frequency of the power; and

a communication filter, connected between the power line and the transmitter, that at least blocks signals at the frequency of the power, while not blocking signals at the carrier frequency.

(2) The communication apparatus according to (1), wherein the transmitter

encodes the processing command in binary,

generates a transmit signal obtained by amplitude-modulating the encoded signal at a frequency lower than the carrier frequency, and

modulates the transmit signal onto a carrier at the carrier frequency, and transmits the modulated result as the carrier signal.

(3) The communication apparatus according to (1) or (2), further including:

a power line communication unit that communicates, via the power line, with an connected external apparatus connected via the port in a wired manner, and acquires from the connected external apparatus identification information indicating the connected external apparatus;

an identifying unit that identifies the connected external apparatus on the basis of identification information; and

a power controller that causes the power to be selectively transmitted to the connected external apparatus;

wherein the power line communication unit transmits, via the power line, a high-frequency signal at a frequency higher than the frequency of the power, and acquires the identification information transmitted by load modulation conducted in the connected external apparatus.

(4) The communication apparatus according to (3), wherein

in the case of transmitting power to the connected external apparatus,

the power controller sets a first transmission state enabling the transmission of power to the connected external apparatus, and

after entering the first transmission state, the transmitter transmits the carrier signal containing a processing command for powering on the connected external apparatus.

(5) The communication apparatus according to (3) or (4), wherein

in the case of not transmitting power to the connected external apparatus,

the transmitter transmits the carrier signal containing a processing command for powering off the connected external apparatus, and

after the carrier signal containing the processing command is transmitted, the power controller sets a second transmission state disabling the transmission of power to the connected external apparatus.

(6) The communication apparatus according to any one of (1) to (5), further including:

a communication unit that communicates with external apparatus;

wherein the transmitter transmits the carrier signal on the basis of a transmit request received by the communication unit.

(7) An electronic apparatus including:

a receiver that receives, via a power line along which power is transmitted, a carrier signal obtained by modulating a transmit signal that has been obtained by encoding a processing command for executing a given process, at a carrier frequency higher than the frequency of the power;

a communication filter, connected between the power line and the receiver, that at least blocks signals at the frequency of the power, while not blocking signals at the carrier frequency; and

a processor that conducts a process indicated by the processing command corresponding to the received carrier signal.
(8) The electronic apparatus according to (7), further including:

a power line communication unit that communicates, via the communication filter and the power line, with an external apparatus connected in a wired manner by the power line;

wherein the power line communication unit communicates with the external apparatus by conducting load modulation on the basis of a signal transmitted from the external apparatus.

(9) A relay node including:

a receiver that receives, via a power line along which power is transmitted, a carrier signal obtained by modulating a transmit signal that has been obtained by encoding a processing command for executing a given process, at a carrier frequency higher than the frequency of the power;

a communication filter, connected between the power line and the receiver, that at least blocks signals at the frequency of the power, while not blocking signals at the carrier frequency; and

a transmitter that transmits the transmit signal corresponding to the received carrier signal to an external apparatus.

(10) The relay node according to (9), further including:

a power line communication unit that communicates, via the communication filter and the power line, with an external apparatus connected in a wired manner by the power line;

wherein the power line communication unit communicates with the external apparatus by conducting load modulation on the basis of a signal transmitted from the external apparatus.

(11) A communication method including:

generating a transmit signal obtained by encoding a processing command for executing a given process; and

transmitting, via a power line, a carrier signal obtained by modulating the transmit signal at a carrier frequency higher than the frequency of the power.

(12) A communication system including:

a communication apparatus; and

a control apparatus that communicates with the communication apparatus and transmits a transmit request to the communication apparatus;

wherein the communication apparatus includes
a port that connects a power line, along which power is transmitted at a given frequency, to an external apparatus,
a transmitter that transmits, via the power line and on the basis of the transmit request, a carrier signal obtained by modulating a transmit signal that has been obtained by encoding a processing command for executing a given process, at a carrier frequency higher than the frequency of the power, and
a communication filter, connected between the power line and the transmitter, that at least blocks signals at the frequency of the power, while not blocking signals at the carrier frequency.

The present disclosure contains subject matter related to that disclosed in Japanese Priority Patent Application JP 2012-050434 filed in the Japan Patent Office on Mar. 7, 2012, the entire content of which is hereby incorporated by reference.

What is claimed is:

1. A communication apparatus comprising:
a port that connects a power line, along which power is transmitted at a given frequency, to an external apparatus;
a transmitter that transmits, via the power line, a carrier signal obtained by modulating a transmit signal that has been obtained by encoding a processing command for executing a given process, at a carrier frequency higher than the frequency of the power; and
a communication filter, connected between the power line and the transmitter, that at least blocks signals at the frequency of the power, while not blocking signals at the carrier frequency.

2. The communication apparatus according to claim 1, wherein the transmitter
encodes the processing command in binary,
generates a transmit signal obtained by amplitude-modulating the encoded signal at a frequency lower than the carrier frequency, and
modulates the transmit signal onto a carrier at the carrier frequency, and transmits the modulated result as the carrier signal.

3. The communication apparatus according to claim 1, further comprising:
a power line communication unit that communicates, via the power line, with an connected external apparatus connected via the port in a wired manner, and acquires from the connected external apparatus identification information indicating the connected external apparatus;
an identifying unit that identifies the connected external apparatus on the basis of identification information; and
a power controller that causes the power to be selectively transmitted to the connected external apparatus;
wherein the power line communication unit transmits, via the power line, a high-frequency signal at a frequency higher than the frequency of the power, and acquires the identification information transmitted by load modulation conducted in the connected external apparatus.

4. The communication apparatus according to claim 3, wherein
in the case of transmitting power to the connected external apparatus,
the power controller sets a first transmission state enabling the transmission of power to the connected external apparatus, and
after entering the first transmission state, the transmitter transmits the carrier signal containing a processing command for powering on the connected external apparatus.

5. The communication apparatus according to claim 3, wherein
in the case of not transmitting power to the connected external apparatus,
the transmitter transmits the carrier signal containing a processing command for powering off the connected external apparatus, and
after the carrier signal containing the processing command is transmitted, the power controller sets a second transmission state disabling the transmission of power to the connected external apparatus.

6. The communication apparatus according to claim 1, further comprising:
a communication unit that communicates with external apparatus;
wherein the transmitter transmits the carrier signal on the basis of a transmit request received by the communication unit.

7. An electronic apparatus comprising:
a receiver that receives, via a power line along which power is transmitted, a carrier signal obtained by modulating a transmit signal that has been obtained by encoding a processing command for executing a given process, at a carrier frequency higher than the frequency of the power;
a communication filter, connected between the power line and the receiver, that at least blocks signals at the frequency of the power, while not blocking signals at the carrier frequency; and
a processor that conducts a process indicated by the processing command corresponding to the received carrier signal.

8. The electronic apparatus according to claim 7, further comprising:
a power line communication unit that communicates, via the communication filter and the power line, with an external apparatus connected in a wired manner by the power line;
wherein the power line communication unit communicates with the external apparatus by conducting load modulation on the basis of a signal transmitted from the external apparatus.

9. A relay node comprising:
a receiver that receives, via a power line along which power is transmitted, a carrier signal obtained by modulating a transmit signal that has been obtained by encoding a processing command for executing a given process, at a carrier frequency higher than the frequency of the power;
a communication filter, connected between the power line and the receiver, that at least blocks signals at the frequency of the power, while not blocking signals at the carrier frequency; and
a transmitter that transmits the transmit signal corresponding to the received carrier signal to an external apparatus.

10. The relay node according to claim 9, further comprising:
a power line communication unit that communicates, via the communication filter and the power line, with an external apparatus connected in a wired manner by the power line;
wherein the power line communication unit communicates with the external apparatus by conducting load modulation on the basis of a signal transmitted from the external apparatus.

11. A communication method comprising:
generating a transmit signal obtained by encoding a processing command for executing a given process; and
transmitting, via a power line, a carrier signal obtained by modulating the transmit signal at a carrier frequency higher than the frequency of the power.

12. A communication system comprising:
a communication apparatus; and
a control apparatus that communicates with the communication apparatus and transmits a transmit request to the communication apparatus;
wherein the communication apparatus includes
a port that connects a power line, along which power is transmitted at a given frequency, to an external apparatus,
a transmitter that transmits, via the power line and on the basis of the transmit request, a carrier signal obtained by modulating a transmit signal that has been obtained by encoding a processing command for executing a given process, at a carrier frequency higher than the frequency of the power, and
a communication filter, connected between the power line and the transmitter, that at least blocks signals at the frequency of the power, while not blocking signals at the carrier frequency.
